(19) United States
(12) Patent Application Publication
(10) Pub. No.: US 2025/0101944 A1
(43) Pub. Date: Mar. 27, 2025

(54) Turbine with Rotary Blades

(71) Applicant: Milan Sevcik, Vysocany (CZ)

(72) Inventor: Milan Sevcik, Vysocany (CZ)

(21) Appl. No.: 18/728,993

(22) PCT Filed: Jan. 12, 2023
(86) PCT No.: PCT/CZ2023/050003

§ 371 Date: Jul. 15, 2024

(30) Foreign Application Priority Data
Jan. 28, 2022 (CZ) PV 2022-41
Apr. 27, 2022 (CZ) PV 2022-174

(51) Int. Cl. F03B 17/06; F01D 7/00; F01D 11/08; F03B 11/00

(52) U.S. Cl. CPC F03B 17/067; F01D 7/00; F01D 11/08; F03B 11/006; F05B 2260/74

(57) ABSTRACT

A turbine with rotary blades includes a stator, a rotor rotational about an axis of the turbine and rotational blades evenly spaced around a circumference of the rotor. The turbine includes a pressure chamber circumscribed by a slot and a sealing chamber between which an inlet channel for a medium supply leads into the pressure chamber. The slot, the sealing chamber and the blades are adapted to permanently seal both the slot and the sealing chamber with at least one blade. The rotation of the blades can be ensured by a toothed gear, wherein angular speed of the blades is an integer multiple of the angular speed of the rotor. The blades may have a front wall and a rear wall of approximately conical or cylindrical shape.

### TECHNICAL FIELD

The invention relates to a turbine comprising blades capable of spinning around their own axis. More particularly, the invention relates to a turbine having a pressure chamber into which a medium is pumped, and which is sealed by passing blades.

### BACKGROUND OF THE INVENTION

In general, a turbine represents a machine that converts the kinetic, thermal, and pressure energy of a flowing medium into mechanical work. The energy conversion takes place in a blade grid, composed of blades on one or more rotors stored rotationally. The passage of fluid between the blades causes a force application to them, and this causes the rotor to rotate. The blades can be of different shapes and sizes, they can be rigidly fixed or rotational about their axis, also the angle between the blade and the axis of the turbine can be different. The work performed by the turbine can be used to produce electrical energy in combination with a generator, which is connected to the rotor by a shaft.

The turbine has many uses. It is used as a drive unit in e.g., aircraft engines (for jet aircrafts or as a turboshaft unit in helicopters and propeller aircrafts). It is used to drive turbopumps, e.g., in rockets or gas pipelines. Its use is very important in the energy industry, where turbines are mainly used as primary driving machines for electric alternators, producing electrical energy for the public electrical grid. The turbines of some special types of pumped storage hydroelectric power plants are designed in such a way that they can also serve (in reverse) as water pumps.

Turbines are divided according to several aspects. According to the principle of energy conversion, they are divided into impulse ones, where the turbines change the direction of the fluid flow, which has a high speed and thus also high kinetic energy, and reaction ones, where the turbines produce torque based on the reaction forces when changing the direction and speed of the fluid flow in the space between the rotor blades.

Turbines are further divided according to the medium they process. These can be water turbines, the most famous of which are the Francis turbine, the Pelton turbine, the Kaplan turbine, or the Banki-Michell turbine. Furthermore, gas turbines are known, which are divided into steam turbines and combustion turbines with a heat engine. Another group are turbines using airflow to drive the rotor, that is, wind turbines.

According to the design, turbines are divided into open ones, where the rotor is not closed by the stator body, and closed ones, where the rotor is closed by the stator body.

According to the direction of the medium flow, turbines are divided into axial ones—in which the fluid flows mainly in the direction of the axis of spinning of the rotor, radial ones—in which the direction of the fluid flow changes, but for a significant part of the path is perpendicular to the axis of spinning of the rotor, radiaxial turbines—in which the fluid flow in the impeller changes direction from radial to axial, and tangential turbines—in which the fluid acts tangentially on the impeller.

In the current state of the art, turbines having partially rotary blades are known, such as for example in the automotive industry, where the turbine is part of most vehicles having turbocharged engines, where it forms an integral part of the turbocharger or supercharger. Turbines with rotary blades are also known in the prior art. These variable area turbines (VAT) are an adaptive component that, in conjunction with other adaptive engine elements such as adaptive fans, variable blade compressors, variable nozzles, etc., can provide significant benefits in the overall performance of a gas turbine engine. These benefits can include, but are not limited to, reduced specific fuel consumption (SFC), reduced air temperature at the high-pressure compressor exit, improved throttle response, and increased portion lifespan.

A turbine with rotary blades is also described in the patent number EP3071796, which describes a two-stream gas turbine engine comprising a fan part, a compressor part, a combustion part, and a turbine part. In this case, the blade spin around its axis in a flow rate path defined between the outer diameter and the inner diameter. The blade spin around its axis at a constant distance from the surface of the flow rate path. A disadvantage of this solution is the high losses during the turbine operation, which can adversely affect its operating efficiency. Another disadvantage is the generation of significant vibrations during the turbine operation.

Another turbine with rotary blades is described in the document DE2602597 A1. However, in this solution, there is significant medium leakage in the direction opposite to the drift of the blades, resulting in lower efficiency. In addition, this solution also creates significant vibrations, which affect, among other things, for example the lifespan of the turbine.

Another example of a known turbine with rotary blades is a turbine described in the document DE883563 C. In this turbine, however, the blades have a concavo-convex shape, which is necessary for this turbine for sealing the slot but increases the area of the slot, which reduces the efficiency of the turbine.

It would therefore be advisable to come up with a solution that increases the efficiency of the turbine and minimises the oscillatory movement of the assembly.

### SUMMARY OF THE INVENTION

The disadvantages of the solutions known from the state of the art are to a certain extent eliminated by a turbine with rotary blades including a rotor adapted to spin around the axis of the rotor Z and a stator, wherein the rotor comprises blades arranged circumferentially, and each blade is rotational about its axis. N blades evenly spaced around the axis of the rotor, or the axis of the turbine Z, protrude from the outer surface of the rotor. Each blade includes a front wall and a rear wall, both of which are curved when viewed in the axis of the blade with the centre of curvature to the same side from the blade, and two lateral edges. The thickness of the blade is defined between the front and rear walls. The lateral edges, and possibly other edges of the blade, may be sharp, rounded, and may take the form of relatively narrow walls. Essentially, the curving of the front and rear walls in the same direction means that the blade has a concavo-convex or convexo-concave shape when viewed approximately in the axis of the blade. These walls preferably have a substantially cylindrical or conical area, for example they do not deviate from the cylindrical or conical shape by more than a millimetre, preferably more than half a millimetre, on a majority of their area. It does not necessarily have to be a rotary area but, for example, an area with an elliptical or parabolic base.

The thickness of the blade does not have to be constant throughout width or length thereof. It is preferably measured at each location of the blade as the distance between the front and rear walls, e.g., measured perpendicularly to at least one of these walls.

The turbine further comprises a pressure chamber circumscribed by a front face of the pressure chamber and a rear face of the pressure chamber from both axial directions of the turbine, an inner circumferential wall of the pressure chamber, and an outer circumferential wall of the pressure chamber. The faces and circumferential walls are defined in part by the rotor and in part by the stator. For example, the faces may be planar areas perpendicular to the axis of the turbine. For example, the circumferential walls can be cylindrical or spherical. The beginning of the pressure chamber, i.e., its front end with respect to the direction of the drift or the passage of the blades, is defined by a two-portion partition, wherein a slot for entry of the blade into the pressure chamber is defined between both portions of the partition. Both portions can also be made of one piece of material, e.g., they can be interconnected with each other at one face or one circumferential wall of the pressure chamber. The blade is, in terms of its shape, adapted to closely copy the shape of the slot as it passes through the slot. Close copying means copying the shape with only a small clearance. As the blade passes through the slot, the blade is oriented with one edge forward, that is, during the passage, the front wall of the blade faces one portion of the partition, and the rear wall faces the other. The shape of the front and rear walls, in particular curving thereof, is chosen to achieve this close copying. Said clearance is as small as possible while maintaining the free passage of the blades, for example, it may be in the order of less than a millimetre, preferably less than half a millimetre, more preferably less than a tenth of a millimetre. The direction of the blade passage, i.e., rotation of the rotor, is defined for a state when the turbine is operating as a generator. In general, it can also function as a pump when supplying energy, wherein its rotor then rotates against the direction of the blade passage introduced above.

When viewed in the direction of the axis Z, two lines intersecting on the axis Z and forming an angle

$$β = \frac{360 °}{2 n}$$

are defined for the blade both in the position at the entry to the slot and in the position at the exit from the slot by the axis of the blade, the slot, and the axis Z. Preferably this angle is achieved with such precision that there is a gap of no more than half a millimetre, preferably less than a tenth of a millimetre, between the blades when the two blades pass each other in the slot. Due to the thermal expansion of the materials, the described clearances are preferably measured on a turbine that is already at normal operating temperature. In this view, the slot takes the form of a line segment passing through the nearest points of both portions of the partition and facing towards the axis Z. In this view, the axis Z takes the form of a single point. The axis of the blade can take the form of a line or point, wherein if it takes the form of a line, this line faces to the axis Z. The position at the entry to the slot is therefore the position of the blade determined by the turning of the rotor, and consequently also the turning of the blade, in which the blade edge extends into the narrowest location of the slot and the rest of the blade is in front of the slot (i.e., outside of the pressure chamber), wherein, due to the choice of the beta angle, it meets the previous blade in it, which is approximately in its position at the exit of the slot, where the second lateral edge is at the narrowest location of the slot and the rest of the blade is behind the slot (i.e., inside of the pressure chamber). Essentially, in other words, it can be said that when the rotor rotates a full revolution, there are n moments when the slot ceases to be sealed by a particular blade and begins to be sealed by the next blade, i.e., the blades meet in the slot, so that leakage of the medium through the slot is prevented.

The pressure chamber comprises, in the direction of the drift of the blades, first an inlet channel for the medium supply to the pressure chamber and then a sealing chamber having a length of at least α, wherein

$$α = \frac{360 °}{n} .$$

The centre of the sealing chamber is positioned away from the slot in the direction of the drift of the blades at a range of +65° to +100° or at the same interval against the direction of the drift of the blades. Its location against the direction of the drift of the blades may be more preferable with respect to turbine oscillation. Location in accordance with the direction may be more preferable in terms of production cost and complexity because in such case the pressure chamber is shorter. Preferably, when the blade is rotated by 90° about its axis relative to the turn in the position where its axis passes through the slot, it is in the sealing chamber and seals it with edges thereof. This seal, like the slot seal, is with a small clearance to prevent friction of the blades against the sealing chamber walls. The moment or position at which a certain blade begins to seal the sealing chamber is not necessarily the same moment at which the blade enters the sealing chamber with its entire volume. Sealing can also occur later when the blade is turned in such way that its lateral edges begin to seal against the walls of the sealing chamber. Analogously, the blade may stop sealing the sealing chamber even before it leaves the sealing chamber with part of its volume. The centre of the sealing chamber may then be located at the centre of the axis of the blade trajectory between the position where the blade begins to seal and the position where this blade stops sealing the sealing chamber.

At each position of the turning of the rotor, the slot is sealed by at least one blade and the sealing chamber is sealed by at least one other blade. As mentioned above, it may not be a perfect seal, there may always be a certain clearance between the pressure chamber walls and the blades to allow the blades to move freely. The efficiency of the blade depends, among other things, on the ratio of the cross-sectional area of the sealing chamber to the area of the slot, so that the area of the slot is preferably as small as possible and the area of the sealing chamber where the blades are in engagement is preferably as large as possible, taking into account design requirements, such as for example blade strength. The turbine described above enables this ratio to be achieved at a higher level than turbines known in the state of the art, thus also enabling higher-efficiency function. The curving of both blade walls in the same direction makes it possible to achieve a relatively small blade thickness while maintaining sufficient blade strength when the blade is in engagement and most susceptible to deformation. The permanent sealing of both the slot and the sealing chamber then prevents unwanted passage of the medium and therefore also increases efficiency. The medium drain can be implemented anywhere behind the sealing chamber or behind the last of the sealing chambers if there are more of them. For example, an opening may be provided for free discharging of the medium. I.e., for example, after leaving the pressure chamber, the medium exits the turbine into the free space directly or through the exit pipe.

A turbine with axes of blade rotation parallel to the axis of the rotor Z may be simpler in design than turbines with differently turned axes of the blades. The walls defining the space for rotor and blade movement can also be planar and cylindrical (i.e., in the shape of a part of a rotary cylinder shell). However, a turbine with axes of the blades concurrent to the axis Z may be more preferable in terms of centrifugal forces and the risk of blade deformation caused by them. Some of the walls defining the space for rotor and blade movement may be spherical, for example. This concurrent turning can thus help prevent unwanted blade contact with the partition or chamber walls due to blade deformation. The rotation of the blades is preferably dependent on the rotation of the rotor, in particular at least in the interval between the position at the entry to the slot and the position at the exit from the sealing chamber, more preferably it is dependent on it in all turning positions. This dependence is preferably ensured by the mechanical linkage of the two rotational movements, that is, by the transfer of moment from the rotation of the rotor to the blades.

The turbine may be designed for a gaseous medium and the inlet channel is then preferably provided with a valve. The valve is adapted, for example electronically controlled or mechanically coupled to the rotor, to open the inlet channel for each blade upon entry of given blade into the sealing chamber, and to close the inlet channel upon rotation of the rotor by a maximum of 0.6α, preferably by a maximum of 0.4α in the direction of the drift of the blades relative to the position of the rotor at which the inlet channel was opened. α is the angular distance between the blades as defined above.

With such valve, the efficiency of the gas turbine is increased because the expansion of the medium in the pressure chamber after the valve is closed, not just the momentum of the supplied medium, also contributes to the twirling of the rotor blades. The moment or position of the turning of the rotor in which the valve is opened preferably occurs as close as possible to the moment of the beginning of sealing of the sealing chamber by the given blade. As close as possible here means, for example, in range of ±0.1α from this moment, preferably ±0.05α. Even more preferably, the valve is opened only after the sealing, for example, at the latest at the moment when the rotor is rotated by one tenth of an alpha. The valve must then be re-closed before the sealing chamber is sealed by another blade sufficiently in advance to allow the expansion of the medium to exert a force on the given blade for which the valve was opened and closed. This advance is ensured by closing the valve after rotating it by a maximum of said 0.6α. If the opening of the valve occurs after the sealing chamber is sealed by the blade under consideration, the valve is preferably closed by a max. of 0.5α after opening, more preferably a max. of 0.25α after the valve is opened. At the same time, preferably the valve is not closed until after the rotor has been rotated by 0.05α from its opening, for example, the valve may be closed after being rotated at least by 0.1α or at least by 0.2α, etc.

The rotor can be provided with a speed sensor, e.g., optical, or magnetic one. The valve can then be an electrovalve provided with a control unit that opens and closes the valve in proportion to the speed of rotation of the rotor based on the data from the speed sensor. The valve can also be opened and closed mechanically. For example, the rotor shaft may be circumferentially provided with a cam surface comprising n equal parts around the circumference. The cam surface may be in contact with a connecting rod that is in contact with the valve and, based on the movement of the cam surface or each of n parts thereof, the valve opens at an appropriate moment after sealing the sealing chamber with a blade as described above and then closes the valve.

This turbine can operate with any angle between the axes of the blades and the axis of the rotor Z. The axes of the blades can all intersect on the axis Z or be parallel to the axis Z. The value of this angle can then affect a number of other turbine design parameters, for example the angle between the lateral edges of the blades, which may have the same inclination as the axes of the blades, that is, they may be parallel to the axis Z, or they may approach each other in such way that they intersect at the axis Z, e.g., at approximately the same location as all the axes of the blades, when they are thought to extend. Further, this angle can affect the location of the centre of the sealing chamber or which walls and faces of the pressure chamber are part of the rotor and which are part of the stator.

The number of the blades n can be from 5 to 100. Preferably, it is from 8 to 50, more preferably from 8 to 30. The number of the blades affects the beta and alpha angles introduced above, that is essentially the width of the blades and the length of the sealing chamber. The width of the blades then also affects the width of the sealing chamber, which must be sealable by the blades. Furthermore, as the number of the blades increases, the size of flexure of the front and rear walls of the blades may decrease, which may affects their strength.

The turbine with rotary blades may comprise m pressure chambers, each comprising a sealing chamber, a partition, a slot, and an inlet channel, wherein m is an integer from 1 to 10. In general, m can be greater than 10. Essentially, each blade can then enter the next pressure chamber through its slot after leaving the pressure chamber through its sealing chamber. For all m pressure chambers with their corresponding components, the features mentioned above for these components apply, and other features mentioned below may also apply to them. In particular, all pressure chambers can thus have the same design. However, it is also possible to implement each pressure chamber differently, e.g., with different lengths of the sealing chambers. Preferably, the blades are then adapted to rotate by m revolutions relative to the rotor for each revolution of the rotor.

The turbine can be, for example, a water turbine, a steam turbine, or a gas turbine. The choice of the medium can then, at the discretion of one skilled in the art, affect some of the turbine design parameters.

Preferably, each blade has a plane of symmetry of its own in which the axis of the blade lies, wherein in the position of the blade in the centre of the sealing chamber the axis of the inlet channel forms an angle of less than 15° with the plane of symmetry of the blade. Essentially, the blade having its axis in the centre of the sealing chamber thus has its area approximately perpendicular to the direction of the supplied medium, which is the most suitable angle for effective blade engagement and therefore twirling of the rotor. If the inlet channel is not straight, so that its axis is not a line, the given angle of 15° is measured relative to the direction of the axis at the location where the inlet channel leads into the pressure chamber, i.e., precisely relative to the direction of flow of the medium at its entry to the pressure chamber.

Preferably, the blades are adapted to rotate at an angular speed equal to an integer and non-zero multiple of the rotor angular speed. For example, in the case of the axes of the blades being approximately parallel to the axis of the turbine, the blades can rotate in the same direction as the rotor but also in the opposite direction. In particular, the even dependence between the rotation of the rotor and the blades may be ensured by a toothed gear, which may also include, for example, a chain gear, toothed belt, etc., and which transfers part of the rotor torque to the blades. The most preferable is a gear made of toothed wheels. Said multiple is an integer to maintain the same blade turning at each entry to both the slot and pressure chamber. The advantage of this even rotation, having the angular speed of the blades rotating linearly dependent on the rotor angular speed, is simpler design and minimal vibration and impact.

The blades may also be adapted to oscillatory rotation, that is, rotation back and forth in a closed interval of less than 360°. Such movement can be achieved primarily by using a cam mechanism that guides the shaft of the blade and rotates it as the rotor rotates. The oscillatory rotation allows, for example, more complex blade or sealing chamber shapes to be used, while maintaining the sealing of both the slot and sealing chamber and can reduce space requirements.

Preferably, each blade comprises a reinforcing segment at its free end having an increased thickness. Thus, the thickness is a dimension determined by the width of the slot and the distance between the front and rear walls of the blade. The free end of the blade is the end located between the lateral edges, where the rotary attachment of the blade to the rotor is not implemented. This reinforcing segment will provide the blade with better stability when it is in engagement, so it is less stressed and deformed. As a result, a blade that can withstand a certain load value can, having the reinforcing segment, be thinner over the rest of its length than a blade sized for the same load that does not have a reinforcing segment. Thus, essentially, the cross-section of both the blade and the slot is decreased and thus the ratio between the cross-section of the sealing chamber and the slot is increased, which has a positive effect on the efficiency of the turbine. On a blade turbine having a reinforcing segment, the slot also has an extension at the corresponding end to allow the blade to pass freely through the slot and seal it.

It is also possible to provide the reinforcing segment in the middle of the blade length or elsewhere rather than at the free end thereof. In addition, each blade may also include multiple reinforcing segments spaced along the length of the blade. The shape of the slot would then reflect these extensions. Thus, for example, the blade may include three reinforcing segments where the thickness thereof is increased, and outside of the reinforcing segments the thickness may be constant or narrowing towards the free end of the blade. The slot then comprises three extensions to allow the blade to pass through it and at the same time seal the slot with the blade. Extended segments may, for example, be oval in shape.

Preferably, the thickness of each blade decreases towards its free end over a majority of the blade length. A majority of the length is preferably a majority of the length of the blade part that exits the rotor, i.e., it does not include the blade part that is stored in the rotor. This ensures that the blade is most rigid at the rotary attachment location thereof, where it is also most stressed, and possibly at the free end having the reinforcing segment. Further away from the attachment location, the thickness is then smaller, which again improves the efficiency of the turbine, wherein sufficient blade strength is still maintained. A blade without a reinforcing segment may thin over its entire length.

The shape of the sealing chamber may be defined, for at least a part of the length of the sealing chamber, by the envelope of the compound movement of the edges of the blade passing through the sealing chamber. This compound movement is therefore the spinning around the axis of the blade and about the axis of the turbine. The desired shape of the sealing chamber for a certain blade shape can then be obtained, for example, by a computer simulation. For some blade shapes it may be also possible to obtain it analytically. The edges of the blade include the lateral edges and possibly also an edge at the free end and/or opposite the free end at the location of the rotary attachment. The shape of the sealing chamber is also affected by the number of the blades, the location of the centre of the sealing chamber, etc.

The shape of the slot, that is, its cross-section at its narrowest location, may be defined by the envelope of the compound movement of the front wall and the rear wall of the blade passing through the slot. It is thus defined by a part of the envelope of the compound movement of the blade, this part beginning at the entry of the blade into the slot and ending at its exit from the slot. Similar to above, this is a compound spinning. For a given blade, the shape of the slot can again be obtained, for example, by a computer simulation. It is possible, however, to base the design on a certain slot shape, to obtain from it, on the basis of the desired compound movement of the blades, i.e., said envelope, the shape of the blade in such a way that front and rear walls thereof seal the slot and the edges of the adjacent blades follow each other in the slot, and subsequently the shape of the walls of the sealing chamber can be obtained from the shape of the blade and the given movement.

The axes of the blades may be parallel to the axis of the turbine, wherein the centre of the sealing chamber is located away from the slot in the direction or opposite the direction of the drift of the blades in the range of 65° and 85°, and the lateral edges of each blade are parallel to the axis of the blade. The shape of the front and rear walls of the blade may then be approximately cylindrical. In addition, the axes of the blades may be perpendicular to the axis of the turbine, wherein the centre of the sealing chamber is located away from the slot in the direction of or opposite the direction of the drift of the blades in the range of 80° to 100°, and the lateral edges of each blade approach each other in the direction of the axis of the turbine. It is also possible to use this angle of turning of the axes of the blades on the turbine, where the lateral edges of the blades move further apart from each other towards the axis, wherein the blades are located in the space defined by the rotor and face each other with their free ends. The front and rear walls may then be approximately conical. These two cases of inclination of the axis of the blades essentially represent limiting cases and in general the axis inclination with respect to the axis of the turbine can be anything between 0° and 90°. Or it can be between −90° and 90° since blade turnings are possible from an interval of 180°. Thus, at an angle of −90°, the free ends of the blades can face one point on the axis Z wherein their axes lie in a plane, and at an angle of 90°, the free ends of the blades can face away from each other, wherein axes thereof lie in the same plane. The turning of the axes of the blades concurrent relative to the axis Z may be preferred.

The blades may also be provided with a connecting ring that runs across the entire circumference of the turbine and has a constant cross-section thereon. The free ends of the blades are rotationally attached to the ring, and the ring can be slidingly attached to the stator. The slot is then adapted in its shape to the passage of the ring, which permanently seals the slot at that location. Analogously, the shape of the ring can also affect the cross-section of the sealing chamber. Thanks to the connecting ring, the free ends of the blades support each other in such a way that their flexure is limited, especially the flexure of the blade in engagement. As a result, it is possible to create thinner blades while maintaining sufficient strength, and thus the efficiency of the turbine can be increased. The connecting ring can be used for any turbine described above, in particular for any angle of turning between the axis of the turbine and the axes of the blades, and also for any number and shape of blades, any value of the parameter m, any medium used, etc. The cross-section of the ring may be chosen in such a way that it is sufficiently rigid but at the same time that it can be easily bypassed by the medium, especially if the ring passes through the mouth of the medium supply to the pressure chamber.

The turbine of the invention can be used, for example, to generate electrical energy or, in turn, to pump fluids. For example, it is also possible to use it in flowmeters, especially in turbine flowmeters. A flowmeter using such turbine may be more resistant to changes in flow rate and thus, for example, ensure more accurate measurements for a wider range of possible flow rates.

### CLARIFICATION OF DRAWINGS

A summary of the invention is further clarified using examples of embodiments thereof, which are described with reference to the accompanying drawings, where in:

FIG. 1 a view in the axis Z of the blade and pressure chamber arrangement of a turbine with rotary blades of the invention is schematically shown, wherein the axes of the blades are parallel to the axis Z and one of the blades is currently entering the slot while the previous blade is exiting the slot and the slot is sealed by both blades,

FIG. 2 a view of FIG. 1 is schematically shown with a different turning of the rotor, wherein there is one blade in the slot which seals the slot itself,

FIG. 3 is a perspective view of the rotor having blades and a part of the stator of the turbine of FIGS. 1 and 2, wherein the inner and outer circumferential walls of the stator with both portions of the partition and the outer wall of the sealing chamber are also shown,

FIG. 4 a sectional view of another embodiment of the turbine with the axes of the blades perpendicular to the axis of the turbine is schematically shown, wherein the plane of the section is perpendicular to the slot and intersects it and wherein one of the blades is just entering the slot while the previous blade is exiting the slot and the slot is sealed by both blades,

FIG. 5 the view of FIG. 4 is schematically shown with a different turning of the rotor, wherein there is one blade in the slot which seals the slot itself,

FIG. 6 a sectional view of the inside of the sealing chamber is schematically shown, wherein the sealing chamber is sealed by two blades and the plane of the section is approximately perpendicular to the axes of the blades in the sealing chamber,

FIG. 7 is the view of FIG. 6 with a different turning of the rotor, wherein the sealing chamber is sealed by a single blade in the illustrated position of the turning of the rotor, while the previous blade leaves the sealing chamber and the following blade enters it,

FIG. 8 is a sectional view of the gear mechanism for the first half of the turbine blades of FIGS. 4 to 7, wherein both the axis of the turbine and the slot lie in the plane of the section,

FIG. 9 is a sectional view of the gear mechanism for the second half of the turbine blades of FIGS. 4 to 7, wherein the axis of the turbine and the centre of the sealing chamber lie in the plane of the section,

FIG. 10 is a sectional view of the turbine with the axes of the blades perpendicular to the axis of the rotor, wherein the plane of the section is perpendicular to the axis of the rotor, one of the blades is located in the slot and another of the blades is located in the middle of the sealing chamber,

FIG. 11 a turbine blade is schematically shown with the axes of the blades perpendicular to the axis of the rotor and several exemplary blade cross-sections and a detailed view of the free end of the blade having the reinforcing segment are shown,

FIG. 12 several exemplary sectional views of the turbine along the axis of the turbine are schematically shown, wherein the turbines in these views differ from each other by the turning of the axes of the blades with respect to the axis of the turbine expressed as a gamma angle,

FIG. 13 an embodiment of the turbine of the invention having a valve in the inlet channel coupled by a pair of arms having a cam surface on the rotor is schematically shown,

FIG. 14 the β angle for the blade at the entry to the slot in the embodiment having the axes of the blades parallel to the axis Z is schematically indicated,

FIG. 15 the β angle for the blade at the entry to the slot in the embodiment having the axes of the blades perpendicular to the axis Z is schematically indicated,

FIG. 16 several detailed views of the slot and the beginning of the pressure chamber of the turbine with the axes of the blades perpendicular to the axis Z are schematically indicated, wherein the views are in a direction parallel to the slot and differ from each other by the turning of the rotor,

FIG. 17 several views of the slot and pressure chamber of the turbine having the axes of the blades perpendicular to the axis Z are schematically indicated, wherein the views are in a direction parallel to the axis Z and differ from each other by the turning of the rotor, and

FIG. 18 several detailed views of the sealing chamber of the turbine having the axes of the blades perpendicular to the axis Z are indicated, wherein the views are in a direction approximately parallel to the axes of the blades in engagement and differ from each other by the turning of the rotor.

### EXAMPLES OF THE EMBODIMENTS OF THE INVENTION

The invention will be further clarified using examples of the embodiments with reference to the respective drawings.

The object of the present invention is a turbine with rotary blades 3. This turbine includes a rotor 1, rotational about the axis of the turbine Z, and a stator 2, at least partially surrounding the rotor 1. At least one annular cavity is defined between the rotor 1 and the stator 2, in which the blades 3 are located. The blades 3 are evenly spaced on the circumference or wall of the rotor 1 and are rotationally connected thereto. The rotation of the blades 3 relative to the rotor 1 defines for each blade 3 the axis of the blade 3. The axes of the blades 3 intersect at one point lying on the axis Z or are parallel to the axis Z (i.e., they substantially intersect the axis Z at infinity). In the cavity with the blades 3 there is a pressure chamber 4 into which the inlet channel 8 leads for the supply of the working medium. The beginning of the pressure chamber 4, that is, the location at which the blades 3 enter it when the rotor 1 is rotating, is determined by the partition 5. The partition 5 includes two portions, wherein between the both portions a slot 6 is defined for the tight passage of the blades 3, and it is through this slot 6 that the pressure chamber 4 begins. The both portions of the partition 5 may be rigidly connected together and may be of one piece of material but are separated and distinguishable from each other by the slot 6. The end of the pressure chamber 4 is determined by a sealing chamber 7, which is also adapted for the tight passage of the blades 3, but unlike the slot 6 therein, the blades 3 pass with as much area as possible exposed to the working medium supplied into the pressure chamber 4 through the inlet channel 8. Both the slot 6 and the sealing chamber 7, together with the shape and arrangement of the blades 3, are adapted in such a way that the slot 6 and the sealing chamber 7 are permanently, i.e., each time the rotor 1 is turned, sealed as best as possible by at least one blade 3. The seal may be defined with a small clearance, for example a few tenths of a millimetre, preferably less than one tenth of a millimetre, to ensure free passage of the blades 3 without substantial leakage of the medium between the blades 3 and the partition 5 or the walls of the sealing chamber 7. This clearance may also be chosen with regard to the thermal expansion of the blades 3, for example, when the medium is steam, to avoid friction of the blades 3 against the areas on the stator 2.

Essentially, each blade 3 is therefore adjustable by rotation of the rotor 1 to a series of positions, and in particular at least to the position at the entry to the slot 6, where this blade 3 begins to seal the slot 6, wherein it enters the slot 6 by its lateral edge 11 in front; to the position at the exit from the slot 6, where this blade 3 ceases to seal the slot 6 so that only its opposite lateral edge 11 is substantially in the slot 6, wherein the following blade 3 is in its position at the entry to the slot 6; to the position of the beginning of the sealing of the sealing chamber 7, where the lateral edges 11 of the blade 3 are in the closest possible proximity to some of the walls defining the sealing chamber 7 or abutting on them so that the blade 3 enters the sealing chamber 7 essentially by its front wall 9 or rear wall 10 in front; to the position of the end of the sealing of the sealing chamber 7 by the blade 3, wherein at the latest at the moment when the blade 3 reaches this position, the following blade 3 comes to its position of the beginning of the sealing of the sealing chamber 7, wherein at least between these positions of the beginning and the end of the sealing of the sealing chamber 7, the given blade 3 can be referred to as blade 3 in engagement; the leaving of the sealing chamber 7 in the position of the end of the sealing may also occur with the front wall 9 or the rear wall 10 in front (i.e., the same wall in front as when entering the sealing chamber 7 and beginning of the sealing).

The shape of the blades 3 is defined in such a way that when passing through the slot 6 the blade 3 fits as tightly as possible against the areas or edges of the partition 5 between which the slot 6 is defined. Thus, this shape is determined by the shape of the slot 6 and the compound movement of the blade 3 involving rotation about the axis Z and about the axis of the blade 3. Thus, essentially, the shape of the blade 3, in particular of its front wall 9 and rear wall 10, and also possibly of at least some of its edges, is defined by the envelope of the compound relative movement between the blade 3 and the slot 6, or the areas and edges defining the slot 6. The slot 6 is made as narrow as possible while maintaining sufficient strength of the blade 3 to ensure the highest possible efficiency of the turbine, in particular the highest possible ratio of the area of the sealing chamber 7 to the area of the slot 6. The strength of the blade 3 must be sufficient enough to prevent damage or flexure when the blade 3 is in engagement in the sealing chamber 7; when passing through the slot 6, when the blade 3 is turned by its width along the direction of rotation of the blade 3 about the rotor 1, the stress on the blades 3 is significantly smaller. Each blade 3 includes a front wall 9 and a rear wall 10, connected by the edges of the blade 3 and defining the thickness of the blade 3. Both these walls are curved, preferably both these walls take the form of curves in a cross-section through a plane perpendicular to the axis of the blade 3, the centres of curvature of which lie on the same side from the blade 3 for a majority of such cross-sections. For example, both the front wall 9 and the rear wall 10 may be at least partially defined by a cylindrical or conical wall, wherein the front wall 9 may have a different radius of curving or a different axis location than the rear wall 10 to ensure the above-described requirement for the best possible seal of the slot 6 during the compound movement of the blade 3.

Preferably, the blades 3 narrow towards their free end for at least part of their length. The length is a dimension of the blade 3 measured along its axis. The free end is the one where the blade 3 is not rotationally attached to the rotor 1. This narrowing allows for a further reduction of the cross-section of the slot 6, which has a positive effect on efficiency. At the location of the rotational attachment, the blade 3 is stressed by the pressure of the medium the most, such that more thickness is needed there. In the vicinity of the free end, the blade 3 may then be extended in the direction of its thickness by the reinforcing segment 12, whether or not it narrows longitudinally. In particular, the blade 3 may therefore have an extended border along the free end to increase the strength of the blade 3. The shape of the slot 6 and preferably also the sealing chamber 7 must then reflect this extension so that the slot 6 is then also extended at the corresponding end and preferably the sealing chamber 7 is extended at the corresponding location as well. Alternatively or additionally, the flexure of the blades can be limited by means of a connecting ring in any embodiment. This ring interconnects the free ends of all blades 3 and has a constant cross-section along its entire length, i.e., along the entire circumference of the turbine. The shape of the slot 6 is adapted for sealing at the corresponding end by the passing ring. Similarly, the shape of the sealing chamber 7 may be adapted, for example there may be a groove in its wall in which the ring is slidably seated. The free ends of the blades 3 are rotationally attached to the ring, for example, a pin or mandrel protrudes from each free end that fits into a round opening in the ring, or bearings may also be used.

The pressure chamber 4 is defined by the outer surface of the rotor 1 and the inner surface of the stator 2. These surfaces define the inner and outer circumferential walls of the pressure chamber 4 and further define the front face 13 of the pressure chamber and the rear face 13 of the pressure chamber 4 in the direction of the axis of the turbine. For example, the faces can be planar. Whether the faces or circumferential walls are formed by the rotor 1 or the stator 2 may be affected by the choice of the angle between the axes 28 of the blades 3 and the axis of the turbine. In the direction of passage of the blades 3, the pressure chamber 4 is further defined by the partition 5 with the slot 6 and sealing chamber 7 as mentioned above. When viewed in the direction of the axis Z, it is possible to define a coordinate system of the turbine, for example a right-handed polar coordinate system. Its origin is the projection of the axis Z and the zero axis, that is, the axis, from which the angles are measured in this system in a clockwise direction, is the axis passing through the slot 6, in particular through the narrowest location of the slot 6. If the narrowest location of the slot 6 has a non-negligible length in the direction 29 of the drift of the blades 3, then the zero axis and the location where the blade 3 enters the pressure chamber 4 is considered to be, for example, the centre of this narrowest location.

Between the slot 6 and the beginning of the sealing chamber 7, the pressure chamber 4 is extended so that the supplied medium can pass around the blades 3. The sealing chamber 7 is then substantially a narrowing of the pressure chamber 4, in which the medium can no longer pass freely around the blades 3 so that it must move the blades 3 and thus twirl the rotor 1. Therefore, the shape of the sealing chamber 7 is essentially an envelope of the movement performed by the edges of the blade 3 passing through the given location, where this movement is therefore a composition of two spins. The length of the sealing chamber 7, that is, the size of the angular interval measured in the coordinate system introduced above, is then determined with respect to the number of the blades 3 n located on the rotor 1 in the cavity under consideration in such a way that the sealing chamber 7 is always sealed by at least one blade 3, that is, the following blade 3 enters the sealing chamber 7 at the latest at the moment when the previous blade 3 exits it. Thus, the minimum length of the sealing chamber 7 can be expressed by the angle

$$α = \frac{360 °}{n} ,$$

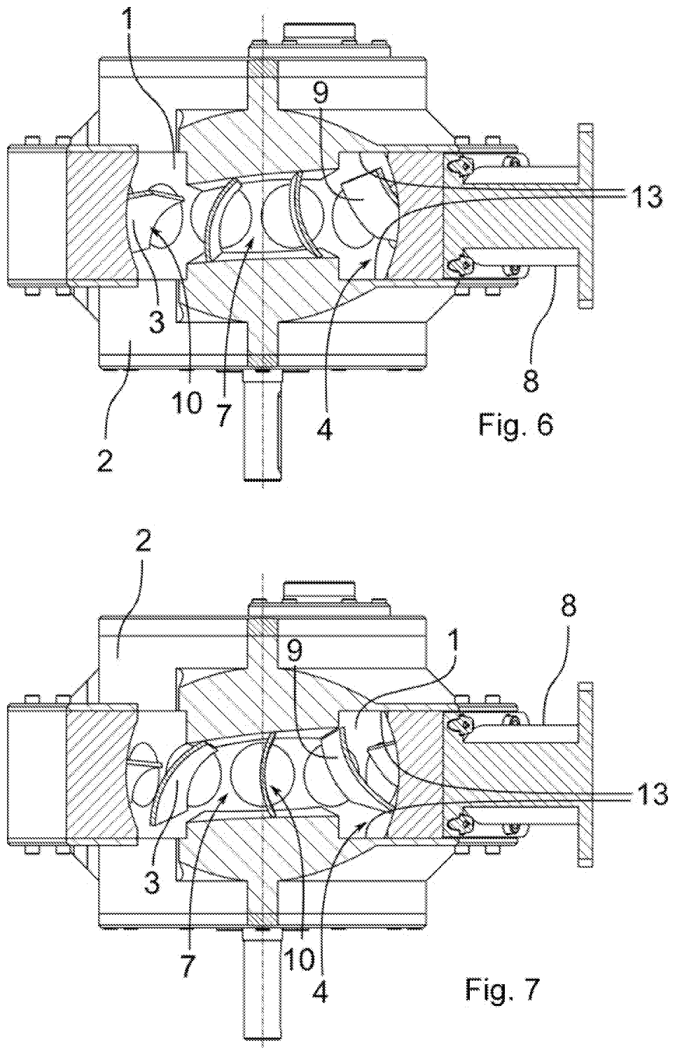

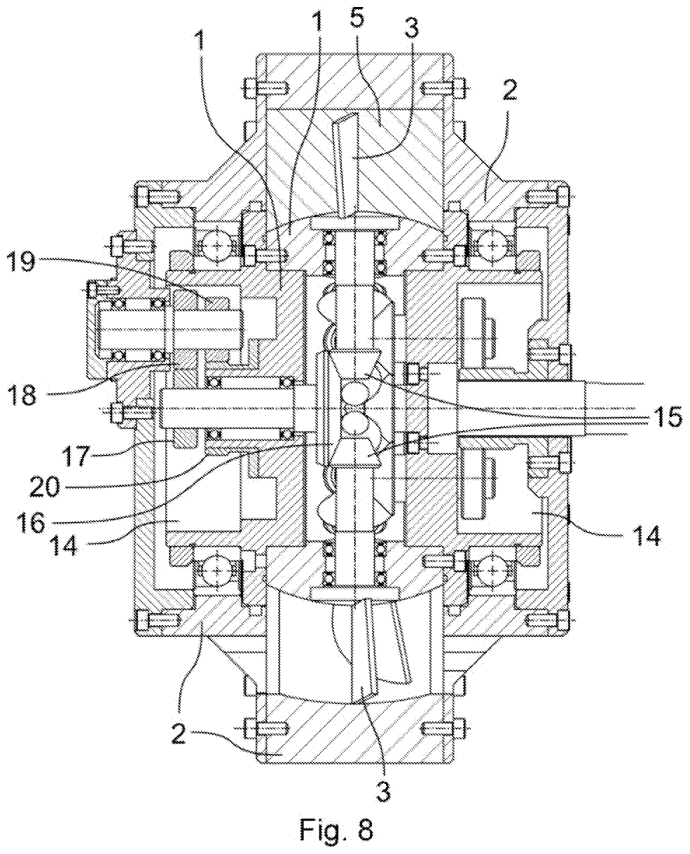

and its centre is preferably located 65°-100° from the zero axis, that is, from the slot 6, either in or against the direction 29 of the drift of the blades, i.e., in the negative direction with respect to the introduced coordinate system. The specific value of this angle of the location of the centre of the sealing chamber 7 depends, among other things, on the angle between the axis of the blades 3 and the axis of the turbine, as will be described in more detail below. The length may be measured, for example, on the circle on which the centre of the sealing chamber 7 lies, but the length on the walls of the chamber may generally be different. The actual length of the sealing chamber 7 will normally be greater than the alpha because the sealing chamber 7 does not need to be sealed by the blade 3 as soon as the blade 3 begins to enter the chamber but must first be aligned therein to a suitable turning for sealing, as can be seen, for example, in FIGS. 6 and 7.

While the permanent sealing of the sealing chamber 7 is ensured in particular by its length in relation to the number of the blades 3, in other words, by the fact that the distance between adjacent blades 3 is less than the length of the sealing chamber 7, the permanent sealing of the slot 6 is ensured in particular by the width of the blades 3, that is, by a dimension measured approximately perpendicular to both the thickness and the length. This width is determined by the number of the blades 3 in such a way that in the state in which a certain blade 3 enters the slot 6 by its lateral edge 11, an isosceles triangle with an angle between the arms

$$β = \frac{360 °}{2 n}$$

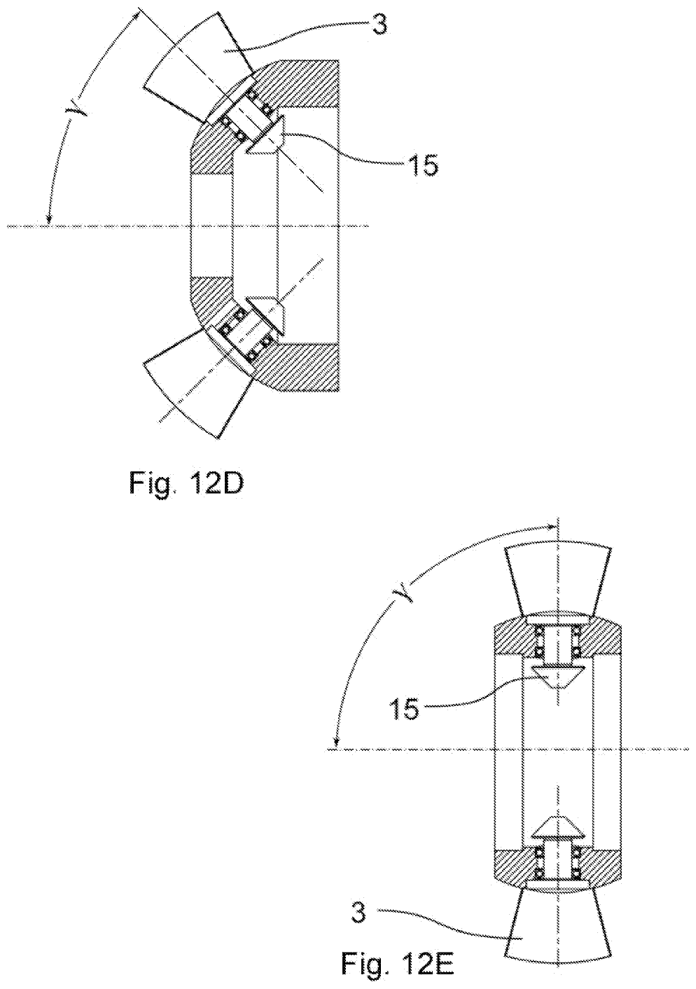

is defined by the axis of this blade 3, the slot 6, and the axis Z when viewed in the direction of the axis Z. Said axes and the slot 6 may form a side of this triangle, a part of a side or vertices thereof, depending on the angle between the axes 28 of the blades 3 and the axis of the turbine. At the same time, the identical triangle is also defined by these elements in the state when the blade 3 leaves the slot 6 by its second lateral edge 11 so that the blade 3 is symmetrical about the plane defined by the axis of the blade 3 and the axis of the turbine when axis thereof passes through the slot 6. This ensures that the slot 6 is permanently sealed, since the following blade 3 enters the slot 6 by its lateral edge 11 while the given blade 3 leaves it. Thus, essentially, the blades 3 in the slot 6 follow each other. The angle between the axes 28 of the blades 3 and the axis of the turbine affects the relative inclination of the lateral, i.e., longitudinally passing, edges of each blade 3, where the lateral edges 11 are thus edges passing approximately along the axis of the blade 3 which are connected by an edge at the free end of the blade 3. In particular, these edges may be parallel (the shape of the blade 3 resembles cylindrical areas on the front wall 9 and the rear wall 10) or they may move further apart towards the free end or approach each other (the front wall 9 and the rear wall 10 are approximately conical, see for example FIGS. 12A to 12E).

The number of the blades 3 n may range, for example, from 5 to 100, more preferably e.g., from 8 to 50, more preferably from 8 to 30. The turbine may include m cavities, each of which includes its own pressure chamber 4. For example, m is an integer from 1 to 10. Each pressure chamber 4 includes a slot 6, a sealing chamber 7, and a medium inlet channel 8. The axis of this channel, regardless of the value of the parameter m, may be approximately perpendicular, e.g., at an angle of 75-105°, more preferably 85-95°, to the cross-section of the sealing chamber 7 through a plane passing through the axis of the turbine and the centre of the sealing chamber 7. In other words, the blade 3 may have a plane of symmetry that is approximately parallel to the axis of the medium inlet channel 8 when the axis of the blade is located at the centre of the sealing chamber 7. Thus, the supplied medium comes into contact with the blade 3 in the sealing chamber 7 in engagement at a suitable angle to achieve the highest possible efficiency, i.e., the medium is supplied approximately perpendicular to the area of the blade 3. The turbine can be, for example, a water, steam, or gas one. When supplying energy and rotating the rotor 1 in the opposite direction, the turbine can also serve as a pumping device or pump for the medium. In the case where m is greater than 1, it is preferable when the rotation of the blades 3 is continuous with a gear ratio of m:1 relative to the rotation of the rotor 1, that is, the blades 3 rotate relative to the rotor 1 by m revolutions per one revolution of the rotor 1 relative to the stator 2.

The speed of rotation of the blades 3 may be directly proportional to the speed of rotation of the rotor 1. This can be achieved, for example, by using toothed gears. For example, the rotation of the blades 3 to the rotation of the rotor 1 may be in a ratio of 1:1. For example, toothed wheels may be mounted on the shafts of the blades 3 that are directly or through another toothed wheel in engagement with a rigidly attached toothed wheel with its centre on the axis of the turbine. The choice of toothed wheels can then be used to achieve the desired gear ratio, which can then affect or in turn be affected by the shape of the elements of the pressure chamber 4, in particular the slot 6, the blades 3 and/or the sealing chamber 7. For example, for a certain shape of the slot 6 it may be necessary to curve the blades 3, i.e., their front walls 9 and rear walls 10, more around their axes if their rotation is faster relative to the rotation of the rotor 1.

The speed of rotation of the blades 3 may also be variable, in particular the blades 3 may perform a swinging movement, that is, rotate about their axis on a closed interval, for example, less than 120° or less than 180° or at least less than 360°, back and forth. This movement may be achieved in particular by a cam mechanism, which may be rigidly located on the stator 2 and may be in contact with elements mounted on the shafts of the blades 3. For example, the cam mechanism may be implemented in such a way that the blades 3 do not rotate about their own axis when they are located in the sealing chamber 7 or at least when they are sealing it. After leaving the sealing chamber 7, the blades 3 can then be rotated in the opposite direction to their initial position. In the case of the use of multiple pressure chambers 4, the blades 3 in each of them can rotate about their own axis analogously.

The choice of the swinging movement then again affects or is affected by the shape of the elements of the pressure chamber 4. For a particular choice of the shape of the slot 6, the shape of the blades 3 will be affected by the compound movement of the blades 3 in the region of the slot 6, whether the rotation is continuous or swinging, and the shape of the sealing chamber 7 will in turn be affected by the shape of the blades 3 and their compound movement. The shapes of these components can be obtained, for example, by a computer simulation, where the choice of the shape of the slot 6 and, if necessary, the choice of the rotatable movement of the blades 3 (which is determined, e.g., by the gear ratio or the form of the cam mechanism, etc., and can be chosen, for example, with respect to the chosen medium, space possibilities, noise requirements, vibration, lifespan, etc.) is used to calculate the shape of the blades 3 and the walls of the sealing chamber 7. In some embodiments, the blades 3 may rotate continuously in the same direction but at a variable speed, i.e., it is neither a swinging movement nor not a movement with a fixed gear ratio. It is also possible to rotate the blades 3 in the opposite direction to that in which the rotor 1 rotates.

For the turbine of the invention designed for a gaseous medium, such as water steam, it is preferable when the inlet channel 8 comprises a valve 24, the opening and closing of which opens and closes the inlet channel 8, which starts and stops the medium supply to the pressure chamber 4. The opening and closing of the valve 24 are synchronized with the rotation of the rotor 1, or with the passage of each blade 3 through the pressure chamber 4.

For each blade 3, the valve 24 is preferably opened just after the sealing chamber 7 by the blade 3. The medium is then immediately after sealing let into the pressure chamber and begins to push on this blade 3. The valve 24 is then closed when the rotor 1 is rotated by an angle δ (delta) relative to its angle of turning when the valve 24 is opened for this blade 3. Preferably, the angle δ is equal to a maximum of 0.6 times alpha, i.e., 60% of the rotation by the distance of the blades 3. Preferably it is a maximum of 0.3 a. The minimum size of the delta angle is preferably 0.1 alpha. After the valve 24 is closed, the medium in the pressure chamber 4, closed on one side by the slot 6, closed on the other side by the sealing chamber 7, and closed from the direction of the inlet channel 8 by the valve 24, expands and continues to push on the blade 3 under consideration sealing the sealing chamber 7. If the sealing chamber 7 is sealed by a plurality of blades 3, the medium pushes on the blade 3 more to the rear, i.e., closer to the inlet channel 8.

Preferably, the valve 24 is opened as close as possible to the moment of sealing the sealing chamber 7 by the blade 3 under consideration. For example, the opening may be performed at an angle of turning of the rotor 1 corresponding to the sealing of the sealing chamber 7 for the blade 3 under consideration ±0.1α, more preferably ±0.05α. I.e., the opening of the valve 24 may also occur just before the sealing of the sealing chamber 7 but preferably occurs after the sealing, and as soon as possible after the sealing.

Opening and closing of the valve 24 can be ensured electronically. I.e., the valve 24 may be an electrovalve controlled with respect to the speed of the rotor 1. Thus, a control unit may be provided for the electrovalve and the speed sensor of the rotor 1, wherein the control unit receives data from this sensor and opens and closes the valve 24 with respect to the turning of the rotor 1 as described above. It is further possible to ensure the opening and closing mechanically, by means of a mechanism coupled directly to the rotor shaft in such a way that each rotation by an alpha angle ensures the opening and closing of the valve 24 with respect to the position of the blade 3 as described above.

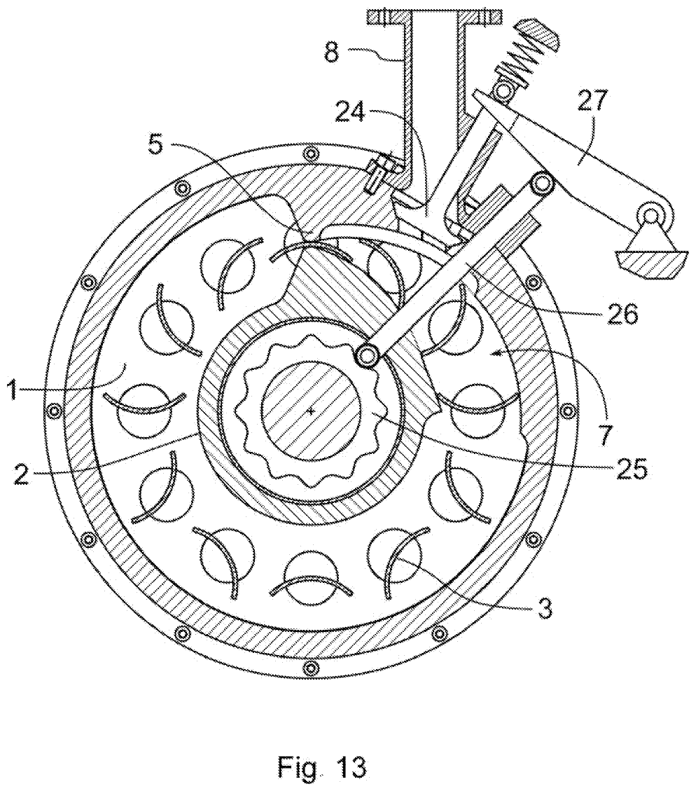

The embodiment of the turbine having the valve 24 is shown in FIG. 13. In this embodiment, the axes of rotation of the blades 3 are parallel to the axis of the rotor 1, but it is possible to place such valve 24 on the turbine with any turning of the axes of the blades 3, with any number and shape of the blades 3, etc. The valve 24 may take the form of a lid shaped to seal the exit from the inlet channel 8. In the illustrated embodiment, movement of the valve 24 is ensured by a cam surface 25 for the valve 24 located about the axis of rotation on the rotor 1. This cam surface 25 for the valve 24 comprises n teeth and n recesses therebetween and is in contact with a first arm 26 that is static with respect to the rotation of the rotor 1 and is slidingly attached to the stator 2 and provided with rollers at each end to reduce friction. At an end spaced from the cam surface 25 for the valve 24, this first arm 26 is propped up by a second arm 27 rotationally attached to the stator 2. This second arm 27 is propped up by the valve 24 in such a way that rotation of the second arm 27 within a closed interval defined by the size of shift of the first arm 26, which in turn is defined by the size of the teeth and the recesses of the cam surface 25 for the valve 24, ensures the shift of the valve 24 between the closed and open positions. Contact of the second arm 27 with the valve 24 is also ensured by a roller to prevent abrasion of the valve 24 and the second arm 27.

When the first arm 26 is in contact with the recess of the cam surface 25 for the valve 24 (see FIG. 13), the valve 24 is closed. When the first arm 26 is in contact with a tooth of the cam surface, the valve 24 is open. The width of these teeth then affects the flow rate time of the medium into the pressure chamber 4 for each blade 3. In the illustrated embodiment, the propping up of the second arm 27 by the top part of the valve 24 is sprung to ensure the closure of the valve 24. This suspension can also help dampen impact and vibration. Alternatively, the cam mechanism for the movement of the valve 24 can be implemented, for example, with a single arm or, in turn, with multiple arms, or a connecting rod may be propped up by the cam that is directly part of the valve 24.

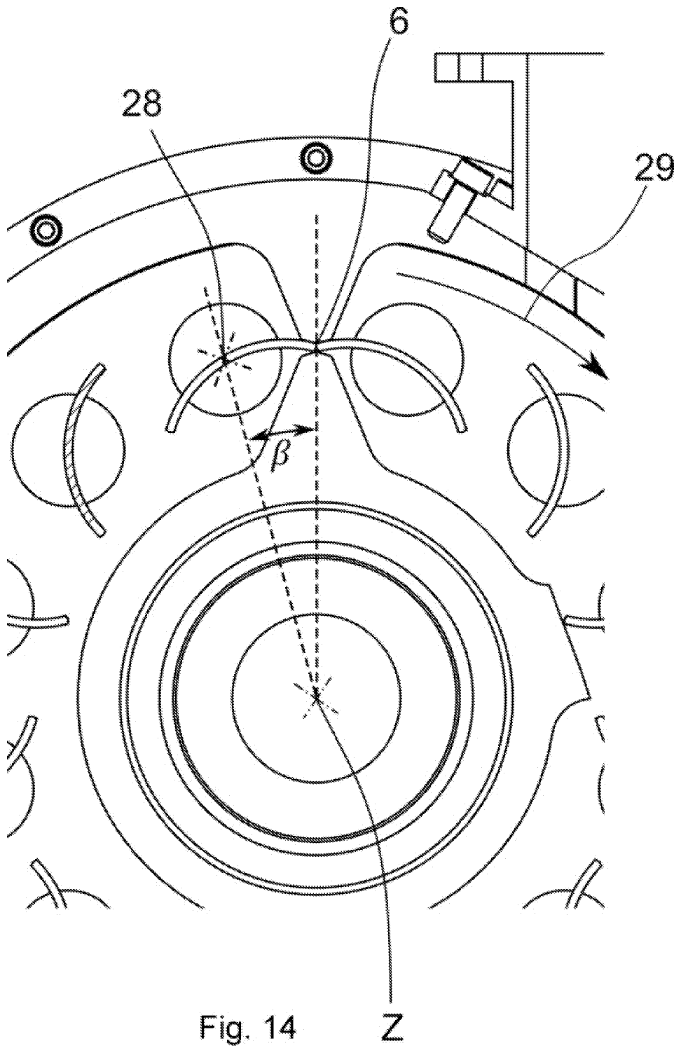

In FIG. 14 the angle β defined by the axis of the blade 3 parallel to the axis Z for the blade 3 at the entry to the slot 6 is indicated. This angle is defined by the junction of the axis Z and the axis 28 of the blade and the junction of the axis Z and the slot 6 when viewed in the direction of the axis Z. In this view, i.e., projected onto a plane perpendicular to the axis Z, both axes are points. The slot, more particularly the narrowest location of the slot which defines the beginning of the pressure chamber and in which the front edge of the blade 3 is located when this blade is in position at the entry to the slot 6, is in this view a line segment facing the axis Z, in FIG. 14 this line segment is defined between the tips of the two portions of the partition 5. For the blade 3 at the exit from the slot 6, this angle β is analogous, which implies that the blades 3 always meet in these two positions in the slot 6, and it is thus permanently sealed.

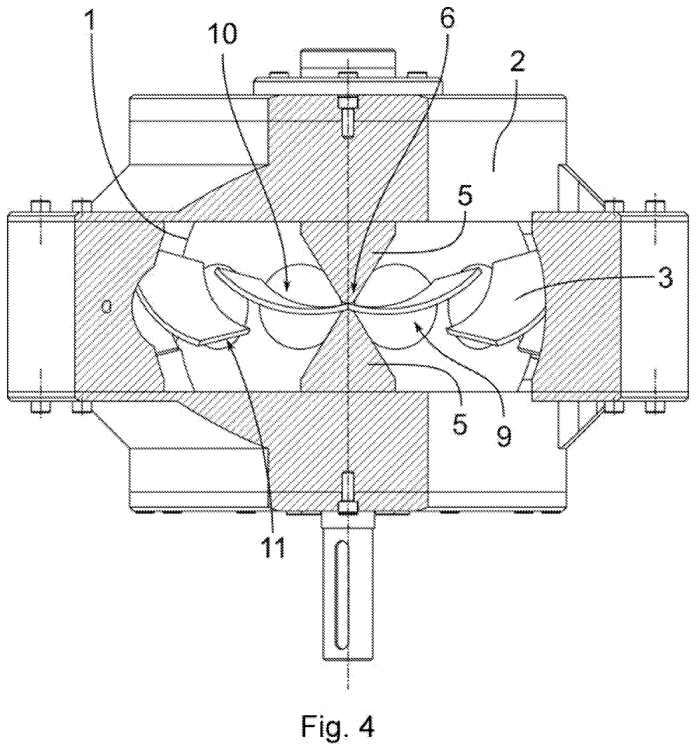

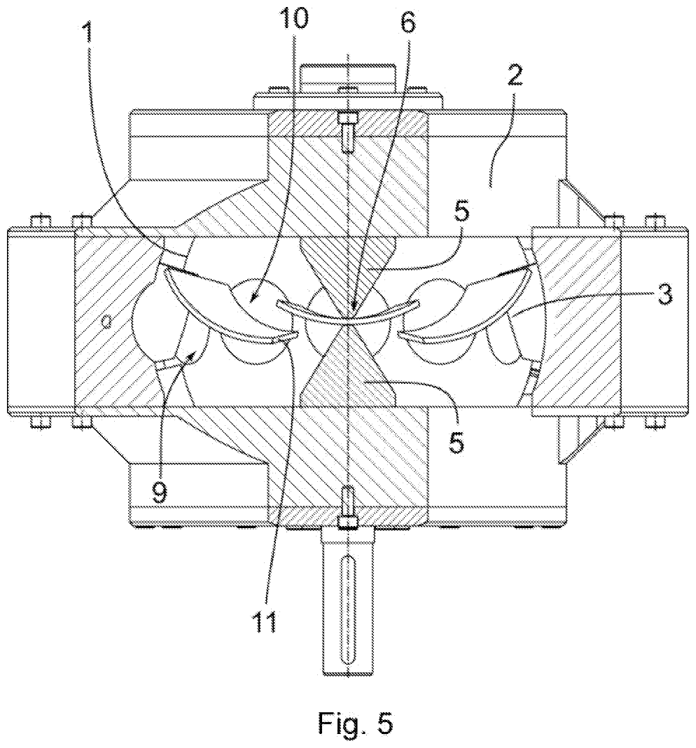

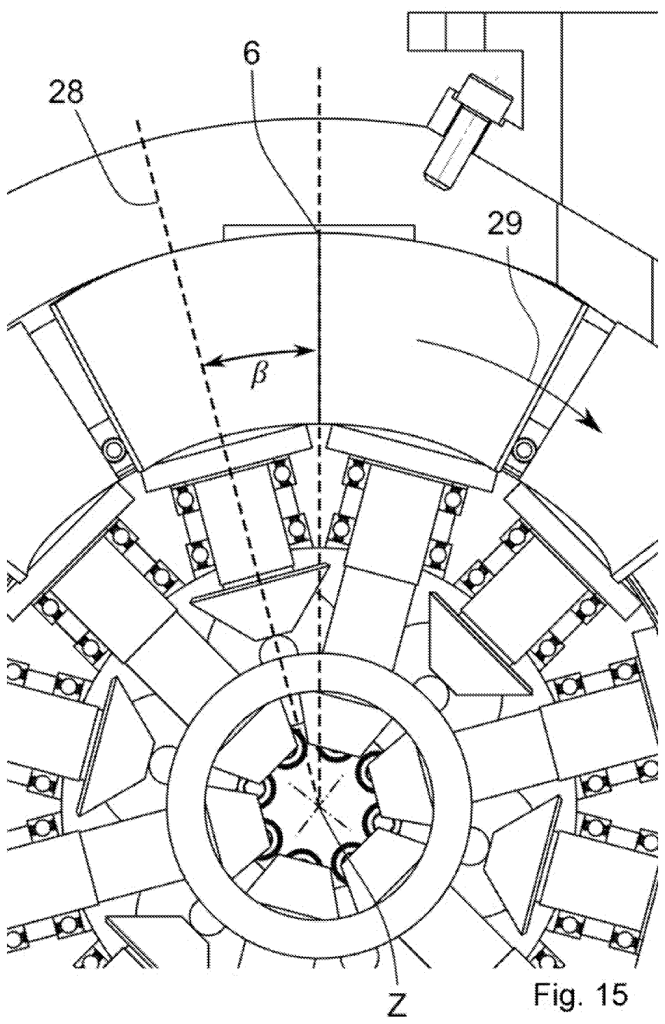

FIG. 15 shows the situation of FIG. 14 for another embodiment, this time with the axes 28 of the blades perpendicular to the axis Z. In the projection into the plane perpendicular to the axis Z, the axis of the blade 3 in the position at the entry to the slot 6 passes through the projection of the axis Z. The slot 6, or its narrowest location, is again a line segment in this view, merging with the dashed line of FIG. 15. In this view, one portion of the partition 5 is hidden behind the blades 3 and the other is not visible because the plane of the section passes between them, but the narrowest location of the slot may again be defined by the tips of these portions, between which the slot 6 is defined. These portions are better seen in FIGS. 4, 5.

The above features can be applied individually or in combinations with each other to the turbines of the invention with any angle between the axes 28 of the blades 3 and the axis of the turbine.

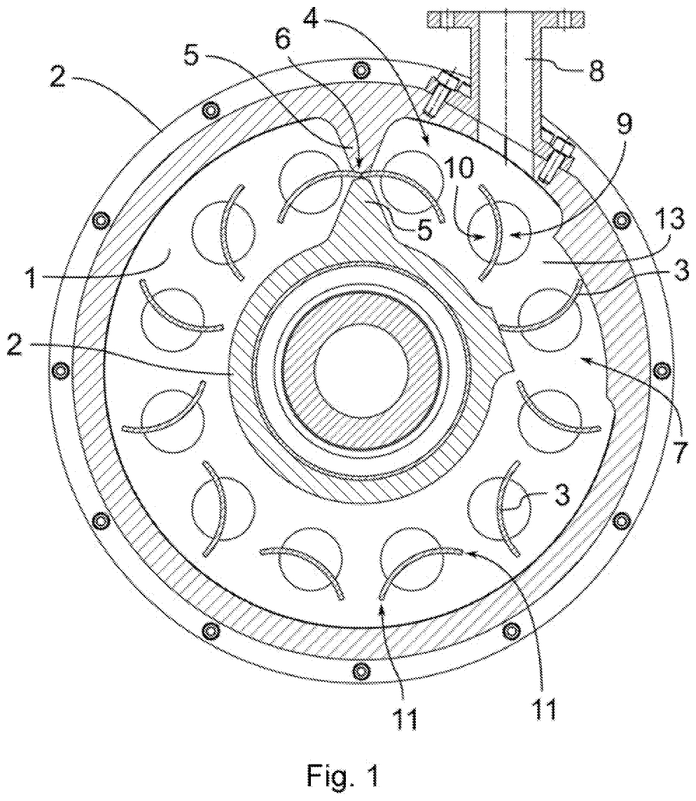

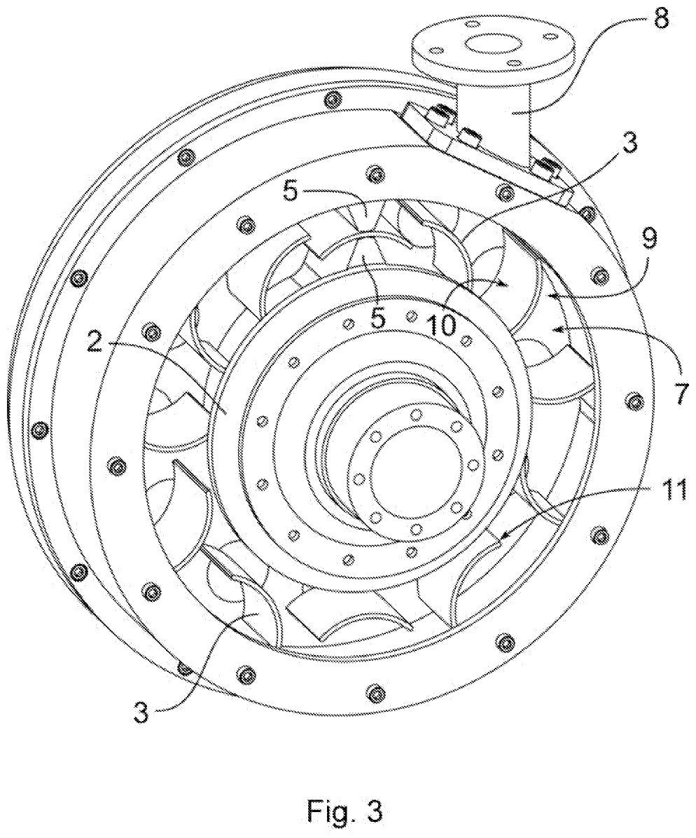

In the first exemplary embodiment illustrated in FIGS. 1-3, the axes of the blades 3 are parallel to the axis of the turbine Z. For the slot 6 defined by the shape of the line segment, the blades 3 have front wall 9 and rear wall 10 in the shape of parts of approximately cylindrical areas, wherein the axis of the cylinder of the front wall 9 does not merge with the axis of the cylinder of the rear wall 10 and/or the radii of these cylinders are different in such a way that both the front wall 9 and the rear wall 10 seal the slot 6 when passing through the slot 6. The wall of the rotor 1 and stator 2 defining the cavity with the blades 3 may be cylindrical so that the lateral edges 11 of the blades 3 may then be straight and parallel to each other. In preferable embodiments having the extension of the free end of the blades 3, the slot 6 will also comprise the extension at the end and both the edges and walls of the blades 3 will have the corresponding shape (rounding, bending, etc.) in the region of the extension, however, the sealing function of the blade 3 will be maintained throughout the passage through the slot 6 and along the entire length of the slot 6. The slot 6 (i.e., its narrowest location located between the opposite edges of the portions of the partition 5) is parallel to the axis Z in this embodiment. The number of the blades 3 n can be, for example 6-24. The width of the blades 3 is then chosen with respect to the number of the blades 3 in such a way that adjacent blades 3 meet in the slot 6 in such a way that it is permanently sealed by at least one blade 3.

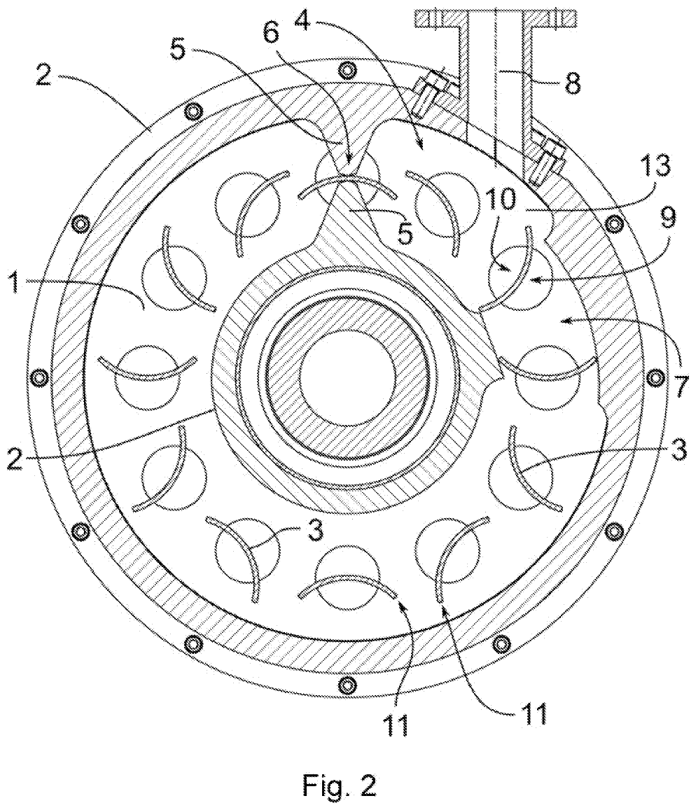

As can be seen from FIGS. 1 and 2, the partition 5 is attached by one portion to the inner circumferential wall of the pressure chamber 4 and by the other portion to the outer circumferential wall of the pressure chamber 4, wherein both these walls are static in this embodiment. At the attachment location, the partition 5 is the thickest in order to provide sufficient strength, and towards the slot 6 between the portions, it narrows so that the slot 6 is narrow in the direction of passage of the blades 3 and the portions of the partition 5 do not prevent the continuous movement of the blades 3. In this embodiment, the blades 3 rotate continuously, wherein for every one revolution of the rotor 1 relative to the stator 2, there is one revolution of the blade 3 about its own axis relative to the rotor 1. However, it is also possible to combine this angle of turning of the axes of the blades 3 with a different gear ratio between the rotation of the blades 3 and the rotor 1, as well as with a swinging movement or a movement with a speed of rotation of the blades 3 that is not directly proportional to the speed of the rotor 1.

In this embodiment, the pressure chamber 4 has a length of 100°, measured in the coordinate system introduced above. The sealing chamber 7 has its centre 75° from the slot 6, has a length of approximately 30° on its inner side when viewed in the axis of the turbine and approximately 50° on its outer side. The beta angle introduced above is therefore 15° in this embodiment so that the width of the blades 3 is approximately 30°. The position of the centre of the sealing chamber 7 may vary, for example by ±10°. Its length may also vary but should always be such that the sealing chamber 7 is permanently sealed by one of the blades 3. For example, the inlet channel 8 for the medium supply may be parallel to the zero axis, as in the illustrated embodiment, but may also generally be inclined, for example, by ±15°. Preferably, the supplied medium directly faces at least approximately the area of the blade 3 in the sealing chamber 7.

The shafts of the blades 3 may pass through the wall of the rotor 1 and behind it they may be provided with toothed wheels wedged, for example, into a rigid toothed wheel if the size of the turbine and the chosen gear ratio allow it, or in other rotational toothed wheels attached to the stator 2, which are wedged into the rigid wheel. In the case of swinging movement of the blades 3, a cam mechanism shaped to ensure the desired movement of the blades 3 during the passage through the sealing chamber 7 may be used instead of toothed gears.

In the second illustrated exemplary embodiment, which is illustrated in FIGS. 4-10, the angle between the axes of all blades 3 and the axis of the turbine is a right angle wherein the axes of the blades 3 intersect at the axis of the turbine. For the slot 6 of the basic, line segment-like shape, the blades 3 may have a front wall 9 and a rear wall 10 defined by substantially a part of the shell of the comical cone, wherein for the front wall 9 and the rear wall 10 the corresponding cones have different axes and/or vertex angles and/or their vertices are shifted with respect to each other in the direction of the axis. The blades 3 extend towards their free ends in the absolute dimension measured, e.g., in mm. Measured in degrees in said polar coordinate system, the width of the blade 3 with the axis in the slot 6 may be constant throughout its length. As in the turbine with the axes 28 of the blades 3 parallel to the axis Z described above, the width is a dimension approximately perpendicular to both the axis of the blade 3 and the thickness thereof, wherein the thickness is by default the smallest dimension ensuring a seal of the slot 6 when the blade 3 passes through, and the width is the dimension ensuring a seal of the sealing chamber 7 when the blade 3 passes through. Thus, the lateral edges 11 of the blade 3 approach each other towards the axis of the turbine. Preferably, the shape of the blades 3 is determined by a cone with a vertex on the axis Z so that the two lateral edges 11 would intersect on the axis Z when extended.

Both the outer surface of the rotor 1 and the inner surface of the stator 2 may have the shape of a part of a spherical area, the edge at the free end of the blade 3 may then have a circular shape for adhering to the stator 2. The slot 6 is perpendicular to the axis Z in this embodiment. Preferably, the slot 6 is extended at its end through which the free ends of the blades 3 pass so that the blades 3 also have a greater thickness at the free end to ensure stability. On the rest of its length, the thickness of the blades 3 may decrease towards the free end. In this embodiment, the pressure chamber 4 is circumscribed by the rotor 1 towards the axis of the turbine and by the stator 2 in the opposite direction and both faces are also part of the stator 2. The number of the blades 3 and thus also the beta (β) angle may be, for example, as described for the first illustrated embodiment above. At the attachment location, the partition 5 is preferably the thickest in order to provide sufficient strength, and towards the slot 6 between the portions, it narrows so that the slot 6 is narrow in the direction of passage of the blades 3 and does not prevent the continuous movement of the blades 3. The partition 5 is attached by its portions to both faces 13 of the pressure chamber 4. In this embodiment, the blades 3 rotate continuously at the same angular speed as the rotor 1. However, it is also possible to combine this angle of turning of the axes of the blades 3 with a different gear ratio between the rotation of the blades 3 and the rotor 1 as well as with a swinging or unevenly fast rotatory movement.

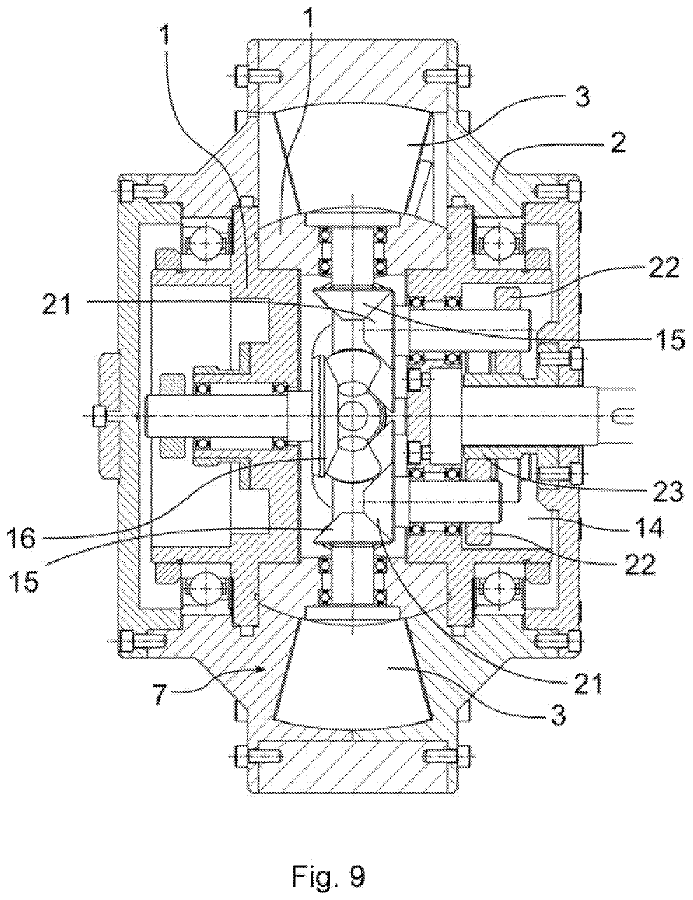

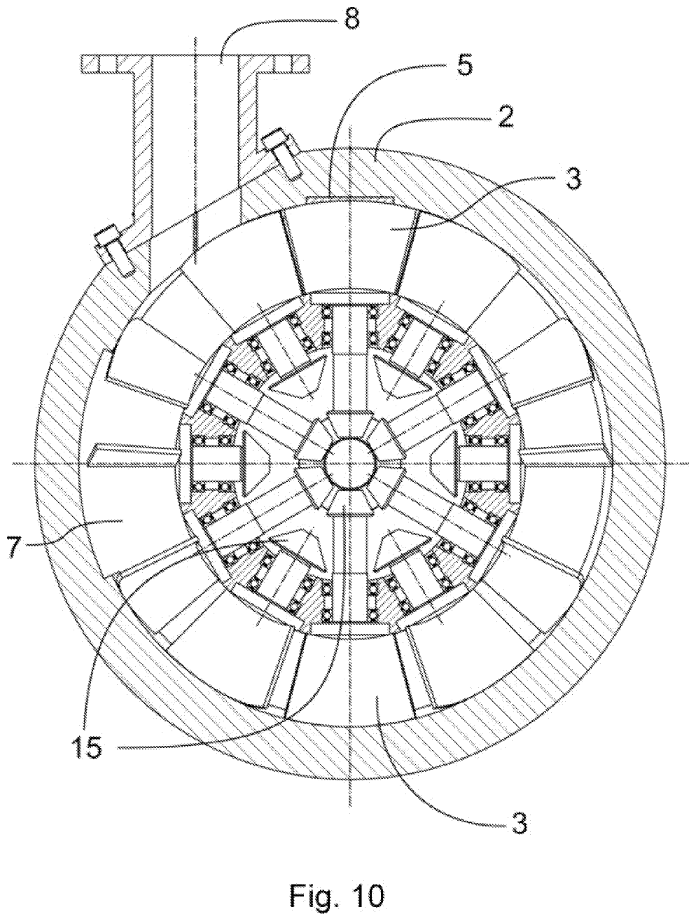

In the illustrated embodiment, the gear mechanism with a 1:1 ratio for rotation of the blades 3 is implemented in such a way that adjacent blades 3 are always wedged into different toothed wheels to make the mechanism as small as possible. This mechanism is indicated in FIGS. 8 and 9. FIG. 8 is a sectional view of the turbine through a plane in which the axis of the turbine and partition 5 lies, and thus showing the gear mechanism for the first half of the blades 3, which includes a series of shafts connected to the blades 3, two auxiliary shafts, and a plurality of toothings. The first auxiliary shaft passes in the axis of the turbine into the toothing chamber 14, through which a space is defined for the movement of the toothings during the spinning of the rotor 1, or a space for the rotation of the rotor 1 around the toothed gears and is rotationally attached to the rotor 1. The second auxiliary shaft is rotationally attached to the stator 2. As can be seen in FIG. 8, the shaft of the blade 3 includes a first toothing 15 wedged into a second toothing 16 on the first auxiliary shaft. The other end of this shaft is wedged by its third toothing 17 into the fourth toothing 18, which is rotationally attached to the stator 2 on the second auxiliary shaft. This shaft is then wedged by its fifth toothing 19 into the sixth toothing 20, which is part of the rotor 1 and is located about the axis of the turbine inside of the toothing chamber 14. Thus, as a result of the rotation of the rotor 1, torque is transmitted from the rotor 1 to the second auxiliary shaft, from it to the first auxiliary shaft and from it to the first half of the blades 3 which are wedged by their first toothings 15 into the common second toothing 16. The gear ratio of the mechanism is then chosen with respect to the space possibilities and requirements for the turbine characteristics by choosing the gear ratio of some of the described toothings. FIG. 8 further shows how the blade 3, as it passes through the slot 6, fits tightly against the walls of the slot 6 and seals it.

FIG. 9 shows the gear mechanism for the second half of the blades 3. The section in this figure has a plane guided perpendicular to the plane of the section in FIG. 8 so that it passes through the sealing chamber 7. This mechanism includes an auxiliary shaft for each blade 3, wherein the first toothing 15 on the shaft of the blade 3 is wedged into the seventh toothing 21 on the auxiliary shaft, which is wedged at the opposite end by its eighth toothing 22 into the ninth toothing 23 located on the stator 2 about the axis Z. In the illustrated embodiment, this ninth toothing 23 closely circumscribes the main shaft of the rotor 1. The mechanism of this second half of the blades 3 also ensures the rotation of the blades 3 due to the rotation between the rotor 1 and the stator 2, with the same gear ratio as the mechanism described in the previous paragraph. Further, in FIG. 9, the sealing of the sealing chamber 7 by the blade 3 is visible and it can be seen how the walls of the sealing chamber 7 follow copy shape of the edges of the blade 3.

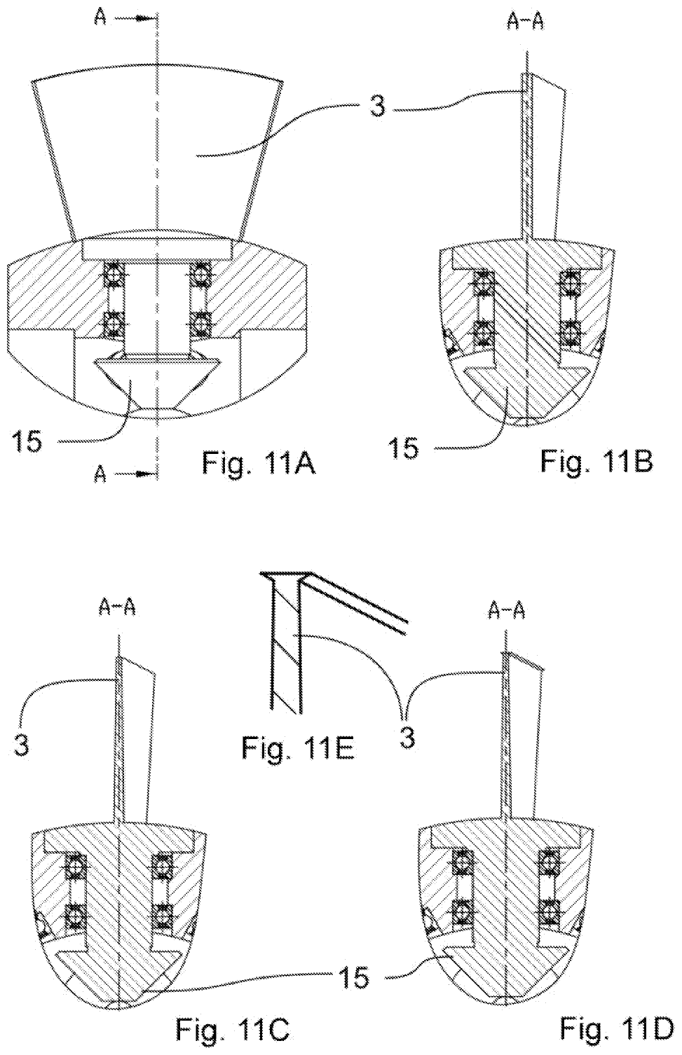

The pressure chamber 4 may have a length of, for example, 100°-135°. The centre of the sealing chamber 7 may be located, for example, 80°-100° from the slot 6, preferably 90° from the slot 6. It is also possible to implement the turbine in such a way that these angles defining the position and size of the chambers are measured against the direction 29 of the drift of the blades, i.e., they are negative. In the view of FIG. 10, the turning of all the blades of the turbine is visible, with centre 90° from the slot. The direction 29 of the drift of the blades 3 is counterclockwise in this view so that the coordinate system is left-handed. It can be further seen in this figure that the adjacent blades 3 have differently long shafts as described above with respect to the gear mechanism. The length of the sealing chamber 7 may be, having twelve blades 3 in the illustrated embodiment, for example 40-70°, preferably 45-60°, for example 50°. It is always chosen in such a way that it is permanently sealed by at least one blade 3 so that for a larger number of the blades 3 it may be shorter, while for fewer blades 3 it may be necessary to increase its length. Beta is 15° in the illustrated embodiment. For example, the inlet channel 8 is turned parallel to the partition 5 so that it is approximately perpendicular to the blade 3 in the sealing chamber 7 but can be turned, for example, by ±15°.

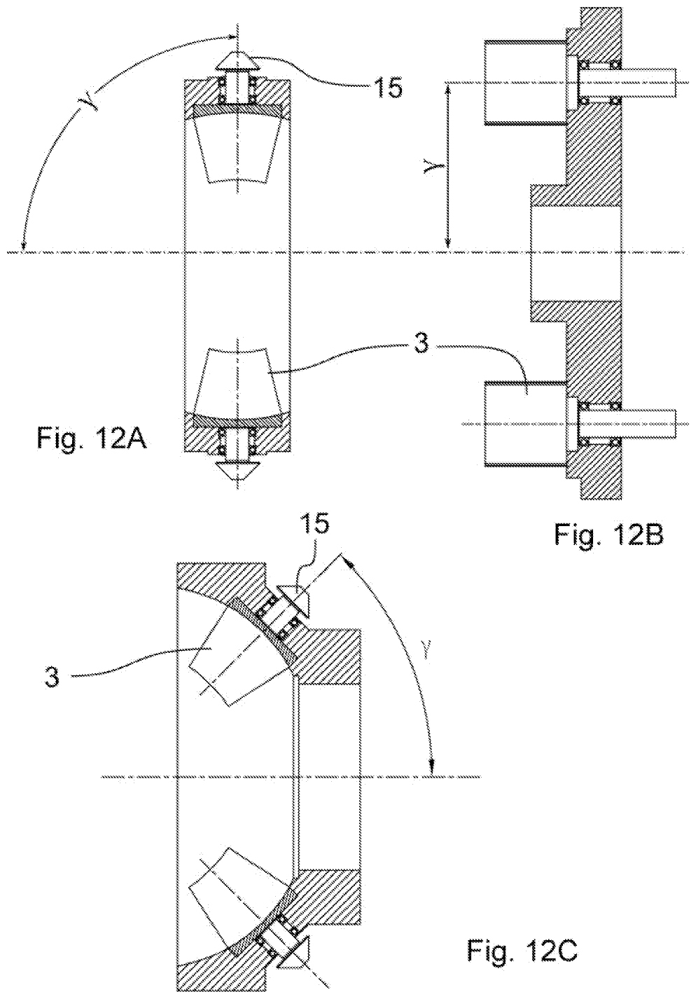

FIG. 11A shows a view of the blade 3 of a conical shape and FIGS. 11B-11D show cross-sections of such blade in several variations. In FIG. 11B, the blade has a constant thickness along its entire length (the entire length here meaning the length of the part of the blade 3 protruding from the rotor 1). In FIG. 11C, the blade narrows along the entire protruding length towards the free end. In FIG. 11D, the blade narrows along a majority of its length and is provided with an extended reinforcing segment 12 at the free end. A detailed view of this segment is shown in FIG. 11E. In general, the reinforcing segment 12 may have substantially any shape, for example, its edges or walls may be rounded to avoid stress concentrations at sharp edges and corners. The reinforcing segment 12 can also be used on a blade 3 with a constant thickness. The reinforcing segment 12 may, for example, have a thickness at its thickest location that is the same as the thickness of the blade 3 immediately next to the rotor 1, which may be, for example, twice the thickness of the blade 3 immediately in front of the reinforcing segment 12. In general, the thickness of the blade 3 and the reinforcing segment 12 may be substantially arbitrary, chosen with regard to other design features of the turbine, in particular to avoid undue deformation of the blade 3 during engagement. Blades 3 having the reinforcing segment 12 elsewhere than near the free end, e.g., in the middle of the length of the blade 3, are also possible. Blades 3 having multiple reinforcing segments 12 are also possible.

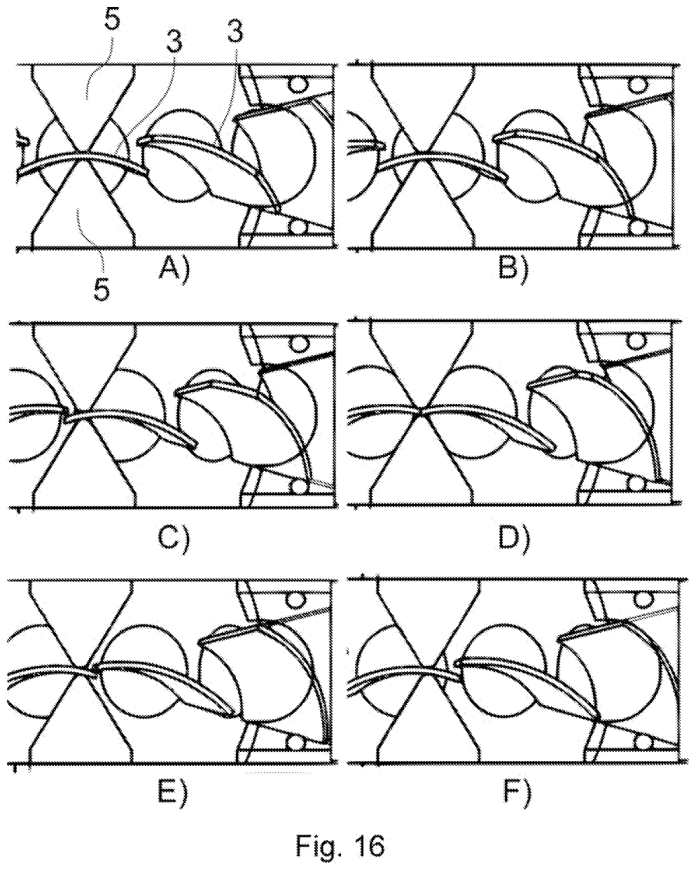

FIG. 16 schematically indicates six views of the partition 5, the slot 6, the beginning of the pressure chamber 4, and several blades 3. Between the views 16A) to 16F), the rotor 1 is turned in the direction of the drift of the blades 3. Between FIGS. 16A) and 16F), the rotor 1 is rotated by less than an angle α. In FIG. 16A), one blade 3 is located with axis in the slot 6. In FIGS. 16B) and 16C), it gradually leaves the slot 6. In FIG. 16D), it is in a position at the exit from the slot 6 where it has only its rear edge in the slot 6 and the following blade 3 enters the slot 6. In FIGS. 16E) and 16F), this blade 3 under consideration then gradually turns more into a position suitable for sealing the sealing chamber 7 and for engagement after leaving the slot 6.

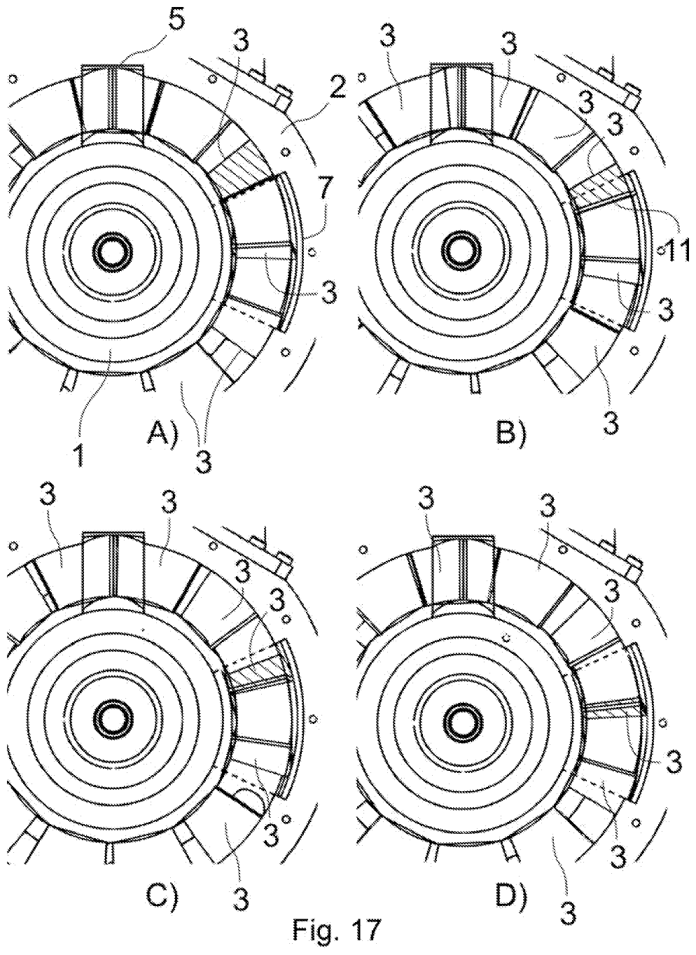

FIG. 17 shows a similar situation in the views in the direction of the axis Z, wherein the entire pressure chamber 4 is visible. Between views 17A) and 17D), the rotor 1 is again rotated by less than an angle α. One of the visible blades 3 is provided with hatching in these views on both the front wall 9 and the rear wall 10, and the entry and exit of the sealing chamber 7 is indicated by a dashed line to facilitate orientation in the figure. In view 17A), the blade 3 in question begins to enter the space of the sealing chamber 7 by one of its edges. In view 17B), it is turned more in a position suitable for engagement. In views 17C) and 17D), this blade 3 in question may already be in engagement, while the previous blade 3 begins to leave the sealing chamber 7 and the following blade 3 approaches the sealing chamber 7. In view 17C), it can also be seen how two other blades 3 meet in the slot 6.

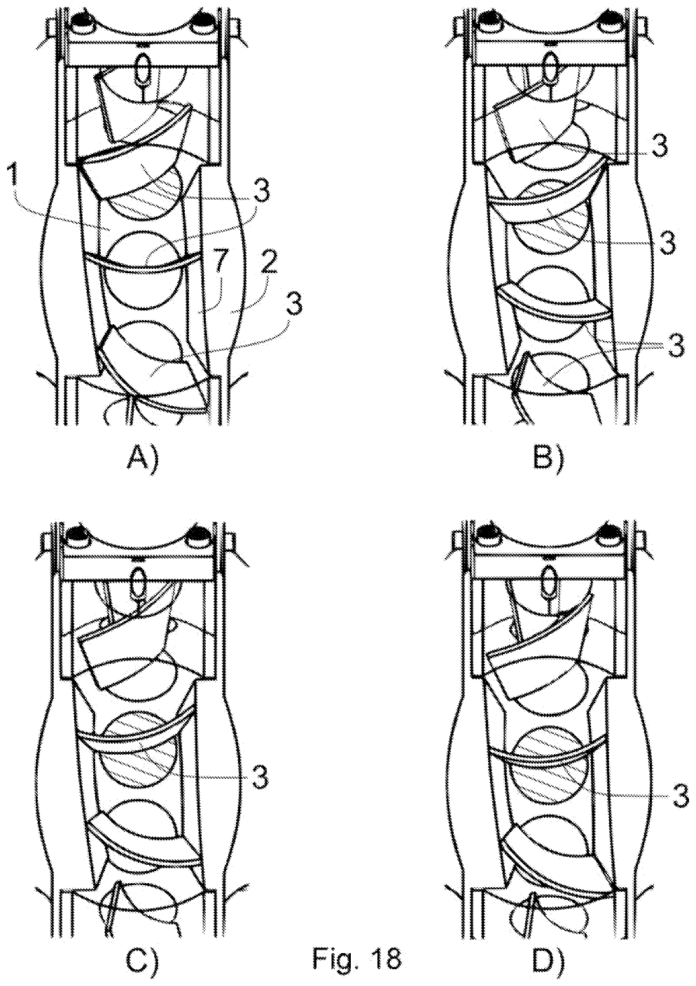

In FIG. 18, the passage of the blades 3 through the sealing chamber 7 is shown in four views perpendicular to the axis Z. One of the blades 3 is again marked with hatching, in this figure the hatching is at the base of the blade 3 ensuring its rotational connection to the rotor 1. In the upper part of these views, a part of the inlet channel 8 screwed to the stator 2 can be seen, this channel leading into the pressure chamber 4 before the beginning of the sealing chamber 7. In FIG. 18A), the blade 3 in question begins to enter the sealing chamber 7, in FIG. 18B), it begins to seal it and is therefore fully in engagement. In FIGS. 18C) and 18D), this blade 3 is still in engagement while the following blade 3 begins to leave the sealing chamber 7.

For the sake of clarity, in FIGS. 16-18, only blades 3 are predominantly marked by the reference numerals, the turning of which (the combination of the spinning 1 about the axis Z and the axis 28 of the blade 3) during the rotation of rotor 1 differs between the different views in these figures. Thus, from these three figures, the movement of the blades 3 is clearly visible to facilitate the understanding of the operation of this turbine.

In other embodiments, the angle between the axes 28 of the blades 3 and the axis of the turbine Z may be any angle from the interval of 0 to ±90°. With respect to the choice of this angle, the inclination of the slot 6 relative to the axis of the turbine may also be varied, the shape of the blades 3, in particular the relative mutual inclination of the lateral edges 11, may be varied, and the location of the centre of the sealing chamber 7 may be varied. In particular, depending on the inclination of the axes of the blades 3, these parameters may vary between the values of the same parameters of the first illustrated exemplary embodiment and the second illustrated exemplary embodiment. For example, for an angle between the axes 28 of the blades 3 and the axis of the turbine of 45°, the slot 6 may also be inclined relative to the axis of the turbine by 45°. The location of the centre of the sealing chamber 7 may be midway between the centre in the first illustrated embodiment and the centre in the second illustrated embodiment. The blades 3 widen towards the free end (when measuring the width in mm), but less rapidly than in the second illustrated embodiment. When viewed in the axis Z, the lateral edges 11 of the blades 3 may be inclined in such a way that they would intersect on the axis Z. In general, it may be that the more the direction of the axes of the blades 3 approaches the direction of the axis of the turbine, the more the cone that defines the shape of the blades 3, in particular the inclination of the lateral edges 11, approaches the shape of a cylinder. The borderline case of this cone is then a cylinder for the turbine with axes 28 of the blades 3 parallel to the axis Z. Further, the centre of the sealing chamber 7 may approach the partition 5 by this change in direction of the axes. The choice of the angle between the axes 28 of the blades 3 and the axis Z may further affects whether the faces 13 of the pressure chamber 4 are both part of the stator 2 or one is part of the rotor 1, and similarly whether the inner and outer circumferential walls thereof are both part of the stator 2 or one is part of the rotor 1 and the other is part of the stator 2, etc. In any embodiment, the turbine may be a gas turbine and may be provided with a valve 24 for closing the medium inlet channel 8.

Five exemplary embodiments of the turbine having different turning of the axes of the blades 3 are shown in FIGS. 12A-12E. In FIG. 12A, the gamma (γ) angle of this turning is ninety degrees, wherein the free ends of the blades 3 face each other and the axis Z. In FIG. 12E, the gamma is also ninety degrees, but the form of the blades 3 corresponds to the turbine described above with respect to FIGS. 4-7. In FIG. 12B, the axes of the blades 3 are parallel to the axis Z, similar to FIGS. 1-4, so that gamma is zero, or one hundred and eighty, degrees. In both FIGS. 12C and 12D, the gamma is 45°, wherein the blades 3 face each other with their free ends and the axis Z (FIG. 12C) or away from it (FIG. 12D), wherein in both of these embodiments the shape of the blades corresponds to a cone with the vertex on the axis Z.

List of reference numerals

```
  1 - Rotor
  2 - Stator
  3 - Blade
  4 - Pressure chamber
  5 - Partition
  6 - Slot
  7 - Sealing chamber
  8 - Inlet channel
  9 - Front wall
10 - Rear wall
11 - Lateral edge
12 - Reinforcing segment
13 - Face of the pressure chamber
14 - Toothing chamber
15 - First toothing
16 - Second toothing
17 - Third toothing
18 - Fourth toothing
19 - Fifth toothing
20 - Sixth toothing
21 - Seventh toothing
22 - Eighth toothing
23 - Ninth toothing
24 - Valve
25 - Cam surface for the valve
26 - First arm
27 - Second arm
28 - Axis of the blade
29 - Direction of the drift of the blades
```

1. A turbine with rotary blades including a rotor adapted to spin around rotor axis Z and a stator, wherein n blades evenly spaced about the axis Z protrude from the outer surface of the rotor, wherein each blade is rotational about its axis, wherein
each blade includes a front wall and a rear wall, both of which are curved when viewed in the axis of the blade with the centre of curvature to the same side from the blade, and two lateral edges,
wherein the turbine further comprises a pressure chamber circumscribed by a front face of the pressure chamber and a rear face of the pressure chamber from both axial directions of the turbine, an inner circumferential wall of the pressure chamber, and an outer circumferential wall of the pressure chamber,
wherein a beginning of the pressure chamber is defined by a two-portion partition, wherein a slot is made for entry of the blade into the pressure chamber between the both portions of the partition and the blade is adapted by its shape to closely copy the shape of the slot when passing through the slot,
wherein for each blade in a position at the exit from the slot, where the blade is located in the pressure chamber and one edge of the blade is located in the slot, the following blade is in a position at the entry to the slot, where the blade is located outside of the pressure chamber and one edge of the blade is located in the slot,
wherein the pressure chamber comprises, in the direction of the drift of the blades, first an inlet channel for medium supply to the pressure chamber and then a sealing chamber having a length of at least α, wherein α=360°/n and a centre of the sealing chamber is located away from the slot in the direction of the drift of the blades in the range of +65° to +100° or −100° to −65°,
wherein at each position of the turning of the rotor, the slot is sealed by at least one blade and the sealing chamber is sealed by at least one other blade.

2. The turbine with rotary blades according to claim 1, wherein the number of the blades n is from 5 to 100.

3. The turbine with rotary blades according to claim 1, wherein the turbine comprises m pressure chambers, each comprising a sealing chamber, partition, slot, and inlet channel, wherein m is an integer from 1 to 10.

4. The turbine with rotary blades according to claim 3, wherein the blades are adapted to rotate about their own axis using a gear ratio of m:1 relative to the speed of rotation of the rotor.

5. The turbine with rotary blades according to claim 1, wherein the turbine is selected from a group consisting of a water turbine, a steam turbine, or a gas turbine.

6. The turbine with rotary blades according to claim 1, wherein each blade has its own plane of symmetry in which the axis of the blade lies, wherein in a position of the blade at the centre of the sealing chamber the axis of the inlet channel forms an angle of less than 15° with the plane of symmetry of the blade.

7. The turbine with rotary blades according to claim 1, wherein the blades are adapted to rotate at an angular speed equal to an integer multiple of the angular speed of the rotor.

8. The turbine with rotary blades according to claim 1, wherein the blades are adapted for oscillatory rotation.

9. The turbine with rotary blades according to claim 1, wherein each blade comprises at its free end a reinforcing segment with an increased thickness.

10. The turbine with rotary blades according to claim 1, wherein the thickness of each blade decreases towards its free end over a majority of the length of the blade.

11. The turbine with rotary blades according to claim 1, wherein the shape of the sealing chamber is defined by an envelope of the compound movement of edges of a blade passing through the sealing chamber.

12. The turbine with rotary blades according to claim 1, wherein the shape of the front wall and rear wall of each blade is defined by an envelope of the compound movement of the blade passing through the slot relative to the slot

13. The turbine with rotary blades according to claim 1, wherein the axes of the blades are parallel to the axis of the turbine, wherein the centre of the sealing chamber is located away from the slot in the direction of the drift of the blades within the range of 65° to 85° or −85° to −65°, and the lateral edges of each blade are parallel to the axis of the blade.

14. The turbine with rotary blades according to claim 1, wherein the axes of the blades are perpendicular to the axis of the turbine, wherein the centre of the sealing chamber is located away from the slot in the direction of the drift of the blades within the range of 80° to 100° or −100° to −80°, and the lateral edges of each blade approach each other in the direction of the axis of the turbine.

15. The turbine with rotary blades according to claim 1, wherein the angle of turning of the axes of the blades relative to the axis of the turbine is chosen from a closed interval of −90° to 90°.

16. The turbine with rotary blades according to any one of the claim 1, wherein the turbine is designed for a gaseous medium and the inlet channel is provided with a valve adapted for each blade to open the inlet channel after the entry of the given blade into the sealing chamber and to close the inlet channel after the rotor has been rotated by a maximum of 0.6α since the opening of the inlet channel.
